(19) United States
(12) Patent Application Publication
(10) Pub. No.: US 2008/0214756 A1
(43) Pub. Date: Sep. 4, 2008

(54) CYCLIC OLEFIN-DIENE COPOLYMER AND PROCESS FOR PRODUCING THE SAME

(75) Inventors: Kohtaro Osakada, Yokohama-shi (JP); Daisuke Takeuchi, Yokohama-shi (JP); Sehoon Park, Yokohama-shi (JP); Makoto Uemura, Chiba-shi (JP); Masayuki Fujita, Chiba-Shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignees: Sumitomo Chemical Company, Limited, Tokyo (JP); Tokyo Institute of Technology, Tokyo (JP)

(21) Appl. No.: 12/036,233

(22) Filed: Feb. 23, 2008

(30) Foreign Application Priority Data
Feb. 28, 2007 (JP) 2007-048399

(51) Int. Cl. C08F 4/606

(52) U.S. Cl. 526/131; 526/308; 526/154

(57) ABSTRACT

A copolymer containing units represented by the defined formula (1) and cyclic olefin units; and a process for producing the copolymer, which comprises the step of copolymerizing a compound represented by the defined formula (3) with a cyclic olefin, the units represented by the formula (1) being polymerized units of the compound represented by the formula (3) such as isopropylidene diallylmalonate.

### FIELD OF THE INVENTION

The present invention relates to a cyclic olefin-diene copolymer having an excellent heat resistance, and a process for producing the cyclic olefin-diene copolymer.

### BACKGROUND OF THE INVENTION

There are known in the art non-conjugated diene compounds such as isopropylidene diallylmalonate represented by the formula (3) mentioned hereinafter, which have two carbon-to-carbon double bonds.

### SUMMARY OF THE INVENTION

However, it is not known in the art to copolymerize the above-mentioned diene compound with a cyclic olefin, thereby obtaining a cyclic olefin-diene copolymer, which contains units represented by the formula (1) mentioned hereinafter and cyclic olefin units.

In view of the above-mentioned circumstances, the present invention has an object to provide a cyclic olefin-diene copolymer having an excellent heat resistance, and a process for producing the cyclic olefin-diene copolymer.

The present invention is a copolymer containing units represented by the following formula (1) and cyclic olefin units:

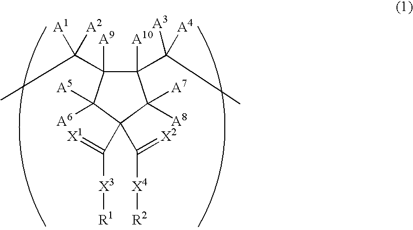

wherein X¹, X², X³ and X⁴ are independently of one another an atom of Group 16 in the Periodic Table of the elements; R¹ and R² are independently of each other a hydrogen atom or a hydrocarbyl group having 1 to 20 carbon atoms, and R¹ and R² may be linked with each other to form a ring; and A¹, A², A³, A⁴, A⁵, A⁶, A⁷, A⁸, A⁹ and A¹⁰ are independently of one another a hydrogen atom, a halogen atom, an alkyl group, an aralkyl group, an aryl group, a substituent-having silyl group, an alkoxy group, an aralkyloxy group, an aryloxy group, a disubstituent-having amino group, or a hydrocarbylthio group, and A⁵ and A⁶, or A⁷ and A⁸ may be linked with each other to form a ring.

Also, the present invention is a process for producing a copolymer containing units represented by the above formula (1) and cyclic olefin units, which comprises the step of copolymerizing a compound represented by the following formula (3) with a cyclic olefin:

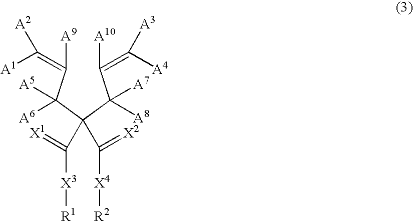

wherein all the symbols contained in the formula (3) are the same as those defined in the formula (1).

In the present invention, the term “unit” contained in the above-mentioned “units represented by the formula (1)” and “cyclic olefin units” means a polymerization unit of a monomer such as a compound represented by the formula (3) and a cyclic olefin.

### DETAILED DESCRIPTION OF THE INVENTION

Examples of X¹, X², X³ and X⁴ in the above formulas are an oxygen atom, a sulfur atom and a selenium atom. Among them, preferred is an oxygen atom.

Examples of the hydrocarbyl group of R¹ and R² in the above formulas are linear alkyl groups such as a methyl group, an ethyl group, and a n-butyl group; branched alkyl groups such as isopropyl group, an isobutyl group, a tert-butyl group, and a neopentyl group; and cyclic alkyl groups such as a cyclohexyl group and a cyclooctyl group. R¹ and R² are preferably an alkyl group having 1 to 20 carbon atoms, more preferably an alkyl group having 1 to 10 carbon atoms and having no substituent, and further preferably a methyl group, an ethyl group, or a n-butyl group.

When R¹ and R² are linked with each other to form a ring, examples of the ring are aliphatic rings and aromatic rings. Those rings may have one or more substituents. Examples of a divalent group forming the aliphatic ring are a methylene group, an ethane-1,2-diyl group, an isopropylidene group, a propane-1,3-diyl group, a propane-1,2-diyl group, a butane-1,2-diyl group, a butane-1,3-diyl group, a butane-2,3-diyl group, a butane-1,4-diyl group, a pentane-1,2-diyl group, a pentane-1,3-diyl group, a pentane-1,4-diyl group, a pentane-1,5-diyl group, an ethylene-1,2-diyl group, a cyclohexane-1,2-diyl group, a cyclohexane-1,3-diyl group, a norbornane-1,2-diyl group, a norbornane-1-ene-1,2-diyl group, a butan-1-ene-1,2-diyl group, a butan-1-ene-1,3-diyl group, a butan-1-ene-2,3-diyl group, a butan-2-ene-1,2-diyl group, a butan-2-ene-1,3-diyl group, a butan-2-ene-2,3-diyl group, a butan-1,3-diene-1,2-diyl group, a butan-1,3-diene-1,3-diyl group, a butan-1,3-diene-1,4-diyl group, a dimethyl-2,3-butene-2,3-diyl group, and a pentene-2,4-diyl group. Among them, preferred is a methylene group, an isopropylidene group, a butan-2-ene-2,3-diyl group, or a butane-2,3-diyl group. Examples of a divalent group forming the aromatic ring are a benzene-1,2-diyl group, a 3-methylbenzene-1,2-diyl group, a 4-methylbenzene-1,2-diyl group, a 3-ethylbenzene-1,2-diyl group, a 4-ethylbenzene-1,2-diyl group, a 3-n-propylbenzene-1,2-diyl group, a 4-n-propylbenzene-1,2-diyl group, a 3-n-butylbenzene-1,2-diyl group, a 4-n-butylbenzene-1,2-diyl group, a 3-isopropylbenzene-1,2-diyl group, a 4-isopropylbenzene-1,2-diyl group, a 3-isobutylbenzene-1,2-diyl group, a 4-isobutylbenzene-1,2-diyl group, a 3-tert-butylbenzene-1,2-diyl group, a 4-tert-butylbenzene-1,2-diyl group, a benzene-1,3-diyl group, a 2-methylbenzene-1,3-diyl group, a 4-methylbenzene-1,3-diyl group, a biphenyl-2,2′-diyl group, a benzene-1,2-dimethylene group, a benzene-1,3-dimethylene group, and a naphthalene-1,8-diyl group.

Examples of the halogen atom of A¹, A², A³, A⁴, A⁵, A⁶, A⁷, A⁸, A⁹ and A¹⁰ in the above formulas are a fluorine atom, a chlorine atom, a bromine atom, and an iodine atom. Among them, preferred is a fluorine atom.

Examples of the alkyl group of A¹, A², A³, A⁴, A⁵, A⁶, A⁷, A⁸, A⁹ and A¹⁰ in the above formulas are linear alkyl groups such as a methyl group, an ethyl group, and a n-butyl group; branched alkyl groups such as isopropyl group, an isobutyl group, a tert-butyl group, and a neopentyl group; and cyclic alkyl groups such as a cyclohexyl group and a cyclooctyl group.

Examples of the aralkyl group of A¹, A², A³, A⁴, A⁵, A⁶, A⁷, A⁸, A⁹ and A¹⁰ in the above formulas are a benzyl group, a phenethyl group, a 2-methylbenzyl group, a 3-methylbenzyl group, a 4-methylbenzyl group, a 2,6-dimethylbenzyl group, and a 3,5-dimethylbenzyl group. The aralkyl group may have a substituent such as a halogen atom, a hydrocarbyloxy group, a nitro group, a sulfonate group, a silyl group, and a cyano group.

Examples of the aryl group of A¹, A², A³, A⁴, A⁵, A⁶, A⁷, A⁸, A⁹ and A¹⁰ in the above formulas are a phenyl group, a tolyl group, and a mesityl group. The aryl group may have a substituent such as a halogen atom, a hydrocarbyloxy group, a nitro group, a sulfonate group, a silyl group, and a cyano group.

Examples of the substituent-having silyl group of A¹, A², A³, A⁴, A⁵, A⁶, A⁷, A⁸, A⁹ and A¹⁰ in the above formulas are a trimethylsilyl group, a diethylmethylsilyl group, an ethyldimethylsilyl group, and a triethylsilyl group. The substituent-having silyl group may have a substituent such as a halogen atom, a hydrocarbyloxy group, a nitro group, a sulfonate group, a silyl group, and a cyano group.

Examples of the alkoxy group of A¹, A², A³, A⁴, A⁵, A⁶, A⁷, A⁸, A⁹ and A¹⁰ in the above formulas are linear alkoxy groups such as a methoxy group, an ethoxy group, and a n-butoxy group; branched alkoxy groups such as an isopropoxy group, an isobutoxy group, a tert-butoxy group, and a neopentoxy group; and cyclic alkoxy groups such as a cyclohexyloxy group and a cyclooctyloxy group. The alkoxy group may have a substituent such as a halogen atom, a hydrocarbyloxy group, a nitro group, a sulfonate group, a silyl group, and a cyano group.

Examples of the aralkyloxy group of A¹, A², A³, A⁴, A⁵, A⁶, A⁷, A⁸, A⁹ and A¹⁰ in the above formulas are a benzyloxy group, a phenethyloxy group, a 2-methylbenzyloxy group, a 3-methylbenzyloxy group, a 4-methylbenzyloxy group, a 2,6-dimethylbenzyloxy group, and a 3,5-dimethylbenzyloxy group. The aralkyloxy group may have a substituent such as a halogen atom, a hydrocarbyloxy group, a nitro group, a sulfonate group, a silyl group, and a cyano group.

Examples of the aryloxy group of A¹, A², A³, A⁴, A⁵, A⁶, A⁷, A⁸, A⁹ and A¹⁰ in the above formulas are a phenoxy group, a 2-methylphenoxy group, a 2-ethylphenoxy group, a 2-n-propylphenoxy group, a 2-isopropylphenoxy group, a 2-n-butylphenoxy group, a 2-isobutylphenoxy group, a 2-tert-butylphenoxy group, a 3-methylphenoxy group, a 3-isopropylphenoxy group, a 3-n-butylphenoxy group, a 3-tert-butylphenoxy group, a 4-methylphenoxy group, a 4-isopropylphenoxy group, a 4-n-butylphenoxy group, a 4-tert-butylphenoxy group, a 2,3-dimethylphenoxy group, a 2,4-dimethylphenoxy group, a 2,5-dimethylphenoxy group, a 2,6-dimethylphenoxy group, a 3,5-dimethylphenoxy group, a 2,6-diisopropylphenoxy group, a 2,6-di-tert-butylphenoxy group, and a naphthoxy group. The aryloxy group may have a substituent such as a halogen atom, a hydrocarbyloxy group, a nitro group, a sulfonate group, a silyl group, and a cyano group.

Examples of the disubstituent-having amino group of A¹, A², A³, A⁴, A⁵, A⁶, A⁷, A⁸, A⁹ and A¹⁰ in the above formulas are linear alkylamino groups such as an N,N-dimethylamino group, an N,N-diethylamino group, and an N,N-di-n-butylamino group; branched alkylamino groups such as an N,N-diisopropylamino group, an N,N-diisobutylamino group, an N,N-di-tert-butylamino group, and an N,N-dineopentylamino group; and cyclic alkylamino groups such as an N,N-dicyclohexylamino group and an N,N-dicyclooctylamino group.

Examples of the hydrocarbylthio group of A¹, A², A³, A⁴, A⁵, A⁶, A⁷, A⁸, A⁹ and A¹⁰ in the above formulas are linear alkylthio groups such a methylthio group, an ethylthio group, and a n-butylthio group; branched alkylthio groups such as an isopropylthio group, an isobutylthio group, a tert-butylthio group, and a neopentylthio group; and cyclic alkylthio groups such as a cyclohexylthio group and a cyclooctylthio group.

Among them, A¹, A², A³, A⁴, A⁵, A⁶, A⁷, A⁸, A⁹ and A¹⁰ are preferably a hydrogen atom, a halogen atom, or an alkyl group having 1 to 10 carbon atoms, more preferably a hydrogen atom or a methyl group, and further preferably a hydrogen atom.

A⁵ and A⁶, or A⁷ and A⁸ may be linked with each other to form a ring. Examples of the ring are aliphatic rings such as a cyclobutane ring, a cyclopentane ring and a cyclohexane ring, and aromatic rings. Those rings may have one or more substituents.

A relative configuration between A⁹ and A¹⁰ in the formula (1) is not particularly limited. In order to improve a heat resistance of the cyclic olefin-diene copolymers of the present invention, the configuration is preferably a trans-form represented by the formula (2), and an amount of units represented by the formula (2) is preferably 50% by mol or larger, and more preferably 95% by mol or larger, the total amount of units represented by the formula (1) being 100% by mol:

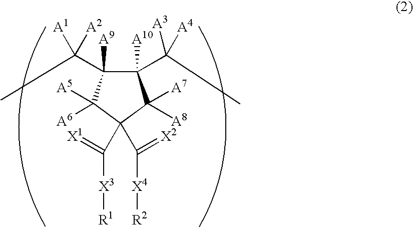

wherein all the symbols contained in the formula (2) are the same as those defined in the formula (1).

A proportion of the above-mentioned trans-form is measured with a ¹³C-NMR spectrum, which is obtained using a chloroform-d₁ solution of the copolymer of the present invention. A peak (i) appearing at 45 to 48 ppm in the ¹³C-NMR spectrum is assigned to carbon atoms having a trans-form configuration, and a peak (ii) appearing at 39 to 42 ppm therein is assigned to carbon atoms having a cis-form configuration, provided that a peak assigned to chloroform-d₁ appears at 77 ppm. Therefore, the proportion (% by mol) of the trans-form is obtained from the following formula:

proportion (% by mol) of trans-form=area of peak (i)×100/[area of peak (i)+area of peak (ii)].

Examples of the compound represented by the above formula (3) are diallyldicarboxylic acid esters. Among them, particularly preferred is isopropylidene diallylmalonate, dimethyl diallylmalonate, diethyl diallylmalonate, diisopropyl diallylmalonate, or di-tert-butyl diallylmalonate, all of these compounds being known in the art.

Examples of the cyclic olefin in the present invention are cyclopropene, cyclobbutene, cyclopentene, cyclohexene, cycloheptene, cis-cyclooctene, trans-cyclooctene, cis-cyclononene, trans-cyclononene, norbornene, α-pinene, β-pinene, limonene, and camphene. Among them, preferred are cyclic olefins having 3 to 20 carbon atoms, further preferred are cyclic olefins having 5 to 12 carbon atoms, and particularly preferred is cyclobbutene, cyclopentene, cyclohexene or norbornene. The “cyclic olefin unit” in the present invention means a unit of a polymerized cyclic olefin (in other words, a polymerization unit of a cyclic olefin), and specifically means a divalent group formed by a cleavage-polymerization reaction of one of two carbon-to-carbon double bonds contained in a cyclic olefin. For example, a unit of a polymerized cyclobutene is a cyclobutane-1,2-diyl group.

Examples of the copolymer of the present invention are random copolymers obtained by randomly copolymerizing the above-exemplified compound represented by the formula (3) with the above-exemplified olefin. Representative examples thereof are a copolymer of isopropylidene diallylmalonate with cyclobutene, a copolymer of dimethyl diallylmalonate with cyclobutene, a copolymer of diethyl diallylmalonate with cyclobutene, a copolymer of diisopropyl diallylmalonate with cyclobutene, a copolymer of di-tert-butyl diallylmalonate with cyclobutene, a copolymer of isopropylidene diallylmalonate with cyclopentene, a copolymer of dimethyl diallylmalonate with cyclopentene, a copolymer of diethyl diallylmalonate with cyclopentene, a copolymer of diisopropyl diallylmalonate with cyclopentene, a copolymer of di-tert-butyl diallylmalonate with cyclopentene, a copolymer of isopropylidene diallylmalonate with cyclohexene, a copolymer of dimethyl diallylmalonate with cyclohexene, a copolymer of diethyl diallylmalonate with cyclohexene, a copolymer of diisopropyl diallylmalonate with cyclohexene, a copolymer of di-tert-butyl diallylmalonate with cyclohexene, a copolymer of isopropylidene diallylmalonate with norbornene, a copolymer of dimethyl diallylmalonate with norbornene, a copolymer of diethyl diallylmalonate with norbornene, a copolymer of diisopropyl diallylmalonate with norbornene, and a copolymer of di-tert-butyl diallylmalonate with norbornene.

An amount of units represented by the formula (1) contained in the copolymer of the present invention is not particularly limited, and is preferably 0.1 to 99.9% by weight, the total of those units and cyclic olefin units being 100% by weight.

The copolymer of the present invention can be produced according to a process comprising the step of copolymerizing the compound represented by the formula (3) with at least a cyclic olefin. The copolymerization is preferably carried out in the presence of a polymerization catalyst formed by contacting a transition metal compound with an organoaluminum compound and/or boron compound.

The transition metal compound is not particularly limited as long as it has an addition polymerization activity, and may be a compound known in the art. Among them, preferred is a transition metal compound having a transition metal of Groups 4 to 10 or lanthanide series in the Periodic Table of the elements. Examples of the transition metal compound are those represented by the following formula (4), and a μ-oxo transition metal compound, which is a dimmer obtained by reacting the transition metal compound with water:

LₐM¹X¹_{b} (4)

wherein M¹ is a transition metal atom of Groups 4 to 10 or lanthanide series of the Periodic Table of the elements (IUPAC 1985); L is a cyclopentadiene-containing anionic group or a hetero atom-having group, and when plural Ls exist, they may be linked with one another directly or through a group having a carbon atom, a silicon atom, a nitrogen atom, an oxygen atom, a sulfur atom or a phosphor atom; X¹ is a halogen atom or a hydrocarbyl group having 1 to 20 carbon atoms; a is a number satisfying 0<a≦8; and b is a number satisfying 0<a≦8.

Examples of M¹ are a titanium atom, a zirconium atom, a hafnium atom, a vanadium atom, a niobium atom, a tantalum atom, a chromium atom, an iron atom, a ruthenium atom, a cobalt atom, a rhodium atom, a nickel atom, a palladium atom, a samarium atom, and an ytterbium atom.

Examples of the above-mentioned cyclopentadiene-containing anionic group of L are a cyclopentadienyl group, a substituent-having cyclopentadienyl group, an indenyl group, a substituent-having indenyl group, a fluorenyl group, and a substituent-having fluorenyl group.

Specific examples of the cyclopentadiene-containing anionic group are an η⁵-cyclopentadienyl group, an η⁵-methylcyclopentadienyl group, an η⁵-tert-butylcyclopentadienyl group, an η⁵-1,2-dimethylcyclopentadienyl group, an η⁵-1,3-dimethylcyclopentadienyl group, an η⁵-1-tert-butyl-2-methylcyclopentadienyl group, an η⁵-1-tert-butyl-3-methylcyclopentadienyl group, an η⁵-1-methyl-2-isopropylcyclopentadienyl group, an η⁵-1-methyl-3-isopropylcyclopentadienyl group, an η⁵-1,2,3-trimethylcyclopentadienyl group, an η⁵-1,2,4-trimethylcyclopentadienyl group, an η⁵-tetramethylcyclopentadienyl group, an η⁵-pentamethylcyclopentadienyl group, an η⁵-indenyl group, an η⁵-4,5,6,7-tetrahydroindenyl group, an η⁵-2-methylindenyl group, an η⁵-3-methylindenyl group, an η⁵-4-methylindenyl group, an η⁵-5-methylindenyl group, an η⁵-6-methylindenyl group, an η⁵-7-methylindenyl group, an η⁵-2-tert-butylindenyl group, an η⁵-3-tert-butylindenyl group, an η⁵-4-tert-butylindenyl group, an η⁵-5-tert-butylindenyl group, an η⁵-6-tert-butylindenyl group, an η⁵-7-tert-butylindenyl group, an η⁵-2,3-dimethylindenyl group, an η⁵-4,7-dimethylindenyl group, an η⁵-2,4,7-trimethylindenyl group, an η⁵-2-methyl-4-isopropylindenyl group, an η⁵-4,5-benzindenyl group, an η⁵-2-methyl-4,5-benzindenyl group, an η⁵-4-phenylindenyl group, an η⁵-2-methyl-5-phenylindenyl group, an η⁵-2-methyl-4-phenylindenyl group, an η⁵-2-methyl-4-naphthylindenyl group, an η⁵-fluorenyl group, an η⁵-2,7-dimethylfluorenyl group, and an η⁵-2,7-di-tert-butylfluorenyl group.

Examples of the hetero atom in the above-mentioned hetero atom-having group of L are an oxygen atom, a sulfur atom, a nitrogen atom, and a phosphorus atom. Examples of the hetero atom-having group are an alkoxy group; an aryloxy group; a thioalkoxy group; a thioaryloxy group; an alkylamino group; an arylamino group; an alkylphosphino group; an arylphosphino group; an aromatic or aliphatic heterocyclic group containing in its ring at least one atom selected from the group consisting of an oxygen atom, a sulfur atom, a nitrogen atom and a phosphorus atom; and a chelating ligand.

Examples of the hetero atom-having group are an alkoxy group such as a methoxy group, an ethoxy group, a propoxy group, and a butoxy group; an aryloxy group such as a phenoxy group, a 2-methylphenoxy group, a 2,6-dimethylphenoxy group, a 2,4,6-trimethylphenoxy group, a 2-ethylphenoxy group, a 4-n-propylphenoxy group, a 2-isopropylphenoxy group, a 2,6-diisopropylphenoxy group, a 4-sec-butylphenoxy group, a 4-tert-butylphenoxy group, a 2,6-di-sec-butylphenoxy group, a 2-tert-butyl-4-methylphenoxy group, and a 2,6-di-tert-butylphenoxy group; a substituent-having aryloxy group such as a 4-methoxyphenoxy group, a 2,6-dimethoxyphenoxy group, a 3,5-dimethoxyphenoxy group, a 2-chlorophenoxy group, a 4-nitrosophenoxy group, a 4-nitrophenoxy group, a 2-aminophenoxy group, a 3-aminophenoxy group, a 4-aminothiophenoxy group, a 2,3,6-trichlorophenoxy group, and a 2,4,6-trifluorophenoxy group; a thioalkoxy group such as a thiomethoxy group; an alkylamino group such as a dimethylamino group, a diethylamino group, a dipropylamino group, an isopropylamino group, and a tert-butylamino group; an arylamino group such as a diphenylamino group; a pyrrolyl group; a phosphino group such as a dimethylphosphino group; and a aryldioxy group such as a 2-(2-oxy-1-propyl)phenoxy group, a catecholato group, a resorcinolate group, a 4-isopropylcatecholato group, a 3-methoxycatecholato group, a 1,8-dihydroxynahpthyl group, a 1,2-dihydroxynahpthyl group, a 2,2′-biphenyldiol group, a 1,1′-bi-2-naphthol group, a 2,2′-dihydroxy-6,6′-dimethylbiphenyl group, a 4,4′,6,6′-tetra-tert-butyl-2,2′-methylenediphenoxy group, and a 4,4′,6,6′-tetramethyl-2,2′-isobutylidenediphenoxy group.

The above-mentioned chelating ligand in the examples of the hetero atom-having group means a ligand having plural coordinating positions. Examples thereof are acetylacetonate, diimine, oxazoline, bisoxazoline, terpyridine, acylhydrazone, diethylenetriamine, triethylenetetramine, porphyrin, crown ether and cryptate.

As mentioned above, when plural Ls exist, they may be linked (namely, plural cyclopentadiene-containing anionic groups may be linked; plural hetero atom-having groups may be linked; or the cyclopentadiene-containing anionic group and the hetero atom-having group may be linked) with one another directly or through a group having a carbon atom, a silicon atom, a nitrogen atom, an oxygen atom, a sulfur atom or a phosphor atom. Examples of the group having a carbon atom, a silicon atom, a nitrogen atom, an oxygen atom, a sulfur atom or a phosphor atom are an alkylene group such as an ethylene group and a propylene group; a substituent-having alkylene group such as a dimethylmethylene group (an isopropylidene group) and a diphenylmethylene group; a silylene group; a substituent-having silylene group such as a dimethylsilylene group, a diphenylsilylene group, and a tetramethyldisilylene group; and a hetero-atom such as a nitrogen atom, an oxygen atom, a sulfur atom and a phosphorus atom.

Examples of the halogen atom of X¹ in formula (4) are a fluorine atom, a chlorine atom, a bromine atom and an iodine atom, and examples of the hydrocarbyl group having 1 to 20 carbon atoms of X¹ therein are a methyl group, an ethyl group, a n-propyl group, an isopropyl group, a n-butyl group, a phenyl group, and a benzyl group.

Each number of “a” and “b” in formula (4) is determined so that the charge of the transition metal compound represented by formula (4) is neutral, taking account of each valence of M¹, L and X¹.

Examples of the transition metal compound represented by formula (4), wherein M¹ is a titanium atom, are bis(cyclopentadienyl)titanium dichloride, bis(methylcyclopentadienyl)titanium dichloride, bis(n-butylcyclopentadienyl)titanium dichloride, bis(dimethylcyclopentadienyl)titanium dichloride, bis(ethylmethylcyclopentadienyl)titanium dichloride, bis(trimethylcyclopentadienyl)titanium dichloride, bis(tetramethylcyclopentadienyl)titanium dichloride, bis(pentamethylcyclopentadienyl)titanium dichloride, bis(indenyl)titanium dichloride, bis(4,5,6,7-tetrahydroindenyl)titanium dichloride, bis(fluorenyl)titanium dichloride, cyclopentadienyl(pentamethylcyclopentadienyl)titanium dichloride, cyclopentadienyl(indenyl)titanium dichloride, cyclopentadienyl(fluorenyl)titanium dichloride, indenyl(fluorenyl)titanium dichloride, pentamethylcyclopentadienyl(indenyl)titanium dichloride, pentamethylcyclopentadienyl(fluorenyl)titanium dichloride, ethylenebis(cyclopentadienyl)titanium dichloride, ethylenebis(2-methylcyclopentadienyl)titanium dichloride, ethylenebis(3-methylcyclopentadienyl)titanium dichloride, ethylenebis(2-n-butylcyclopentadienyl)titanium dichloride, ethylenebis(3-n-butylcyclopentadienyl)titanium dichloride, ethylenebis(2,3-dimethylcyclopentadienyl)titanium dichloride, ethylenebis(2,4-dimethylcyclopentadienyl)titanium dichloride, ethylenebis(2,5-dimethylcyclopentadienyl)titanium dichloride, ethylenebis(3,4-dimethylcyclopentadienyl)titanium dichloride, ethylenebis(2-ethyl-3-methylcyclopentadienyl)titanium dichloride, ethylenebis(2-ethyl-4-methylcyclopentadienyl)titanium dichloride, ethylenebis(2-ethyl-5-methylcyclopentadienyl)titanium dichloride, ethylenebis(3-ethyl-5-methylcyclopentadienyl)titanium dichloride, ethylenebis(2,3,4-trimethylcyclopentadienyl)titanium dichloride, ethylenebis(2,3,5-trimethylcyclopentadienyl)titanium dichloride, ethylenebis(tetramethylcyclopentadienyl)titanium dichloride, ethylenebis(indenyl)titanium dichloride, ethylenebis(4,5,6,7-tetrahydroindenyl)titanium dichloride, ethylenebis(2-phenylindenyl)titanium dichloride, ethylenebis(2-methylindenyl)titanium dichloride, ethylenebis(2-methyl-4-phenylindenyl)titanium dichloride, ethylenebis(2-methyl-4-naphthylindenyl)titanium dichloride, ethylenebis(2-methyl-4,5-benzoindenyl)titanium dichloride, ethylenebis(fluorenyl)titanium dichloride, ethylene(cyclopentadienyl) (pentamethylcyclopentadienyl)titanium dichloride, ethylene(cyclopentadienyl)(indenyl)titanium dichloride, ethylene(methylcyclopentadienyl)(indenyl)titanium dichloride, ethylene(n-butylcyclopentadienyl)(indenyl)titanium dichloride, ethylene(tetramethylcyclopentadienyl)(indenyl)titanium dichloride, ethylene(cyclopentadienyl)(fluorenyl)titanium dichloride, ethylene(methylcyclopentadienyl) (fluorenyl)titanium dichloride, ethylene (pentamethylcyclopentadienyl)(fluorenyl)titanium dichloride, ethylene(n-butylcyclopentadienyl)(fluorenyl)titanium dichloride, ethylene (tetramethylpentadienyl)(fluorenyl)titanium dichloride, ethylene(indenyl)(fluorenyl)titanium dichloride, isopropylidenebis(cyclopentadienyl)titanium dichloride, isopropylidenebis(2-methylcyclopentadienyl)titanium dichloride, isopropylidenebis(3-methylcyclopentadienyl)titanium dichloride, isopropylidenebis(2-n-butylcyclopentadienyl)titanium dichloride, isopropylidenebis(3-n-butylcyclopentadienyl)titanium dichloride, isopropylidenebis(2,3-dimethylcyclopentadienyl) titanium dichloride, isopropylidenebis(2,4-dimethylcyclopentadienyl)titanium dichloride, isopropylidenebis(2,5-dimethylcyclopentadienyl) titanium dichloride, isopropylidenebis(3,4-dimethylcyclopentadienyl)titanium dichloride, isopropylidenebis(2-ethyl-3-methylcyclopentadienyl)titanium dichloride, isopropylidenebis(2-ethyl-4-methylcyclopentadienyl)titanium dichloride, isopropylidenebis(2-ethyl-5-methylcyclopentadienyl)titanium dichloride, isopropylidenebis(3-ethyl-5-methylcyclopentadienyl)titanium dichloride, isopropylidenebis(2,3,4-trimethylcyclopentadienyl)titanium dichloride, isopropylidenebis(2,3,5-trimethylcyclopentadienyl)titanium dichloride, isopropylidenebis(tetramethylcyclopentadienyl) titanium dichloride, isopropylidenebis(indenyl)titanium dichloride, isopropylidenebis(4,5,6,7-tetrahydroindenyl)titanium dichloride, isopropylidenebis(2-phenylindenyl)titanium dichloride, isopropylidenebis(2-methylindenyl)titanium dichloride, isopropylidenebis(2-methyl-4-phenylindenyl)titanium dichloride, isopropylidenebis(2-methyl-4-naphthylindenyl)titanium dichloride, isopropylidenebis(2-methyl-4,5-benzoindenyl)titanium dichloride, isopropylidenebis(fluorenyl)titanium dichloride, isopropylidene(cyclopentadienyl) (tetramethylcyclopentadienyl)titanium dichloride, isopropylidene(cyclopentadienyl)(indenyl)titanium dichloride, isopropylidene(methylcyclopentadienyl)(indenyl)titanium dichloride, isopropylidene(n-butylcyclopentadienyl)(indenyl) titanium dichloride, isopropylidene(tetramethylcyclopentadienyl)(indenyl)titanium dichloride, isopropylidene (cyclopentadienyl)(fluorenyl)titanium dichloride, isopropylidene(methylcyclopentadienyl)(fluorenyl)titanium dichloride, isopropylidene(n-butylcyclopentadienyl)(fluorenyl)titanium dichloride, isopropylidene(tetramethylcyclopentadienyl) (fluorenyl)titanium dichloride, isopropylidene (indenyl)(fluorenyl)titanium dichloride, dimethylsilylenebis(cyclopentadienyl)titanium dichloride, dimethylsilylenebis(2-methylcyclopentadienyl)titanium dichloride, dimethylsilylenebis(3-methylcyclopentadienyl) titanium dichloride, dimethylsilylenebis(2-n-butylcyclopentadienyl)titanium dichloride, dimethylsilylenebis(3-n-butylcyclopentadienyl) titanium dichloride, dimethylsilylenebis(2,3-dimethylcyclopentadienyl)titanium dichloride, dimethylsilylenebis(2,4-dimethylcyclopentadienyl) titanium dichloride, dimethylsilylenebis(2,5-dimethylcyclopentadienyl)titanium dichloride, dimethylsilylenebis(3,4-dimethylcyclopentadienyl) titanium dichloride, dimethylsilylenebis(2-ethyl-3-methylcyclopentadienyl) titanium dichloride, dimethylsilylenebis(2-ethyl-4-methylcyclopentadienyl) titanium dichloride, dimethylsilylenebis(2-ethyl-5-methylcyclopentadienyl) titanium dichloride, dimethylsilylenebis(3-ethyl-5-methylcyclopentadienyl) titanium dichloride, dimethylsilylenebis(2,3,4-trimethylcyclopentadienyl) titanium dichloride, dimethylsilylenebis(2,3,5-trimethylcyclopentadienyl) titanium dichloride, dimethylsilylenebis(tetramethylcyclopentadienyl)titanium dichloride, dimethylsilylenebis(indenyl)titanium dichloride, dimethylsilylenebis(4,5,6,7-tetrahydroindenyl)titanium dichloride, dimethylsilylenebis(2-phenylindenyl)titanium dichloride, dimethylsilylenebis(2-methylindenyl)titanium dichloride, dimethylsilylenebis(2-methyl-4-phenylindenyl) titanium dichloride, dimethylsilylenebis(2-methyl-4-naphthylindenyl)titanium dichloride, dimethylsilylenebis(2-methyl-4,5-benzoindenyl) titanium dichloride, dimethylsilylene(cyclopentadienyl)(indenyl)titanium dichloride, dimethylsilylene(methylcyclopentadienyl) (indenyl)titanium dichloride, dimethylsilylene(n-butylcyclopentadienyl)(indenyl)titanium dichloride, dimethylsilylene(tetramethylcyclopentadienyl) (indenyl)titanium dichloride, dimethylsilylene(cyclopentadienyl)(fluorenyl)titanium dichloride, dimethylsilylene(methylcyclopentadienyl)(fluorenyl) titanium dichloride, dimethylsilylene(n-butylcyclopentadienyl)(fluorenyl) titanium dichloride, dimethylsilylene(tetramethylcyclopentadienyl)(indenyl) titanium dichloride, dimethylsilylene(indenyl)(fluorenyl)titanium dichloride, cyclopentadienyltitanium trichloride, pentamethylcyclopentadienyltitanium trichloride, cyclopentadienyl(dimethylamido)titanium dichloride, cyclopentadienyl(phenoxy)titanium dichloride, cyclopentadienyl(2,6-dimethylphenyl)titanium dichloride, cyclopentadienyl(2,6-diisopropylphenyl)titanium dichloride, cyclopentadienyl(2,6-di-tert-butylphenyl)titanium dichloride, pentamethylcyclopentadienyl(2,6-dimethylphenyl)titanium dichloride, pentamethylcyclopentadienyl(2,6-diisopropylphenyl)titanium dichloride, pentamethylcyclopentadienyl(2,6-di-tert-butylphenyl) titanium dichloride, indenyl(2,6-diisopropylphenyl)titanium dichloride, fluorenyl (2,6-diisopropylphenyl)titanium dichloride, methylene(cyclopentadienyl)(3,5-dimethyl-2-phenoxy)titanium dichloride, methylene(cyclopentadienyl)(3-tert-butyl-2-phenoxy)titanium dichloride, methylene(cyclopentadienyl)(3-tert-butyl-5-methyl-2-phenoxy)titanium dichloride, methylene(cyclopentadienyl)(3-phenyl-2-phenoxy)titanium dichloride, methylene(cyclopentadienyl)(3-tert-butyldimethylsilyl-5-methyl-2-phenoxy)titanium dichloride, methylene(cyclopentadienyl)(3-trimethylsilyl-5-methyl-2-phenoxy)titanium dichloride, methylene(cyclopentadienyl)(3-tert-butyl-5-methoxy-2-phenoxy) titanium dichloride, methylene(cyclopentadienyl)(3-tert-butyl-5-chloro-2-phenoxy)titanium dichloride, methylene(methylcyclopentadienyl)(3,5-dimethyl-2-phenoxy) titanium dichloride, methylene(methylcyclopentadienyl)(3-tert-butyl-2-phenoxy) titanium dichloride, methylene(methylcyclopentadienyl)(3-tert-butyl-5-methyl-2-phenoxy)titanium dichloride, methylene(methylcyclopentadienyl)(3-phenyl-2-phenoxy) titanium dichloride, methylene(methylcyclopentadienyl)(3-tert-butyldimethylsilyl-5-methyl-2-phenoxy)titanium dichloride, methylene(methylcyclopentadienyl)(3-trimethylsilyl-5-methyl-2-phenoxy)titanium dichloride, methylene(methylcyclopentadienyl)(3-tert-butyl-5-methoxy-2-phenoxy)titanium dichloride, methylene(methylcyclopentadienyl)(3-tert-butyl-5-chloro-2-phenoxy)titanium dichloride, methylene(tert-butylcyclopentadienyl)(3,5-dimethyl-2-phenoxy)titanium dichloride, methylene(tert-butylcyclopentadienyl)(3-tert-butyl-2-phenoxy)titanium dichloride, methylene(tert-butylcyclopentadienyl)(3-tert-butyl-5-methyl-2-phenoxy)titanium dichloride, methylene(tert-butylcyclopentadienyl)(3-phenyl-2-phenoxy) titanium dichloride, methylene(tert-butylcyclopentadienyl)(3-tert-butyldimethylsilyl-5-methyl-2-phenoxy)titanium dichloride, methylene(tert-butylcyclopentadienyl)(3-trimethylsilyl-5-methyl-2-phenoxy)titanium dichloride, methylene(tert-butylcyclopentadienyl)(3-tert-butyl-5-methoxy-2-phenoxy)titanium dichloride, methylene(tert-butylcyclopentadienyl)(3-tert-butyl-5-chloro-2-phenoxy)titanium dichloride, methylene(tetramethylcyclopentadienyl)(3,5-dimethyl-2-phenoxy)titanium dichloride, methylene(tetramethylcyclopentadienyl)(3-tert-butyl-2-phenoxy)titanium dichloride, methylene(tetramethylcyclopentadienyl)(3-tert-butyl-5-methyl-2-phenoxy)titanium dichloride, methylene(tetramethylcyclopentadienyl)(3-phenyl-2-phenoxy) titanium dichloride, methylene(tetramethylcyclopentadienyl)(3-tert-butyldimethylsilyl-5-methyl-2-phenoxy)titanium dichloride, methylene(tetramethylcyclopentadienyl) (3-trimethylsilyl-5-methyl-2-phenoxy)titanium dichloride, methylene(tetramethylcyclopentadienyl) (3-tert-butyl-5-methoxy-2-phenoxy)titanium dichloride, methylene(tetramethylcyclopentadienyl) (3-tert-butyl-5-chloro-2-phenoxy)titanium dichloride, methylene(trimethylsilylcyclopentadienyl) (3,5-dimethyl-2-phenoxy)titanium dichloride, methylene(trimethylsilylcyclopentadienyl) (3-tert-butyl-2-phenoxy)titanium dichloride, methylene(trimethylsilylcyclopentadienyl) (3-tert-butyl-5-methyl-2-phenoxy)titanium dichloride, methylene(trimethylsilylcyclopentadienyl) (3-phenyl-2-phenoxy)titanium dichloride, methylene(trimethylsilylcyclopentadienyl) (3-tert-butyldimethylsilyl-5-methyl-2-phenoxy)titanium dichloride, methylene(trimethylsilylcyclopentadienyl) (3-trimethylsilyl-5-methyl-2-phenoxy)titanium dichloride, methylene(trimethylsilylcyclopentadienyl) (3-tert-butyl-5-methoxy-2-phenoxy)titanium dichloride, methylene(trimethylsilylcyclopentadienyl) (3-tert-butyl-5-chloro-2-phenoxy)titanium dichloride, methylene(fluorenyl)(3,5-dimethyl-2-phenoxy)titanium dichloride, methylene(fluorenyl)(3-tert-butyl-2-phenoxy)titanium dichloride, methylene(fluorenyl)(3-tert-butyl-5-methyl-2-phenoxy) titanium dichloride, methylene(fluorenyl)(3-phenyl-2-phenoxy)titanium dichloride, methylene(fluorenyl)(3-tert-butyldimethylsilyl-5-methyl-2-phenoxy)titanium dichloride, methylene(fluorenyl)(3-trimethylsilyl-5-methyl-2-phenoxy) titanium dichloride, methylene(fluorenyl)(3-tert-butyl-5-methoxy-2-phenoxy) titanium dichloride, methylene(fluorenyl)(3-tert-butyl-5-chloro-2-phenoxy) titanium dichloride, isopropylidene(cyclopentadienyl)(3,5-dimethyl-2-phenoxy) titanium dichloride, isopropylidene(cyclopentadienyl)(3-tert-butyl-2-phenoxy) titanium dichloride, isopropylidene(cyclopentadienyl)(3-tert-butyl-5-methyl-2-phenoxy)titanium dichloride, isopropylidene(cyclopentadienyl)(3-phenyl-2-phenoxy) titanium dichloride, isopropylidene(cyclopentadienyl)(3-tert-butyldimethylsilyl-5-methyl-2-phenoxy)titanium dichloride, isopropylidene(cyclopentadienyl)(3-trimethylsilyl-5-methyl-2-phenoxy)titanium dichloride, isopropylidene(cyclopentadienyl)(3-tert-butyl-5-methoxy-2-phenoxy)titanium dichloride, isopropylidene(cyclopentadienyl)(3-tert-butyl-5-chloro-2-phenoxy)titanium dichloride, isopropylidene(methylcyclopentadienyl)(3,5-dimethyl-2-phenoxy)titanium dichloride, isopropylidene(methylcyclopentadienyl)(3-tert-butyl-2-phenoxy)titanium dichloride, isopropylidene(methylcyclopentadienyl)(3-tert-butyl-5-methyl-2-phenoxy)titanium dichloride, isopropylidene(methylcyclopentadienyl)(3-phenyl-2-phenoxy) titanium dichloride, isopropylidene(methylcyclopentadienyl)(3-tert-butyldimethylsilyl-5-methyl-2-phenoxy)titanium dichloride, isopropylidene(methylcyclopentadienyl)(3-trimethylsilyl-5-methyl-2-phenoxy)titanium dichloride, isopropylidene(methylcyclopentadienyl)(3-tert-butyl-5-methoxy-2-phenoxy)titanium dichloride, isopropylidene(methylcyclopentadienyl)(3-tert-butyl-5-chloro-2-phenoxy)titanium dichloride, isopropylidene(tert-butylcyclopentadienyl)(3,5-dimethyl-2-phenoxy)titanium dichloride, isopropylidene(tert-butylcyclopentadienyl)(3-tert-butyl-2-phenoxy)titanium dichloride, isopropylidene(tert-butylcyclopentadienyl)(3-tert-butyl-5-methyl-2-phenoxy)titanium dichloride, isopropylidene(tert-butylcyclopentadienyl)(3-phenyl-2-phenoxy)titanium dichloride, isopropylidene(tert-butylcyclopentadienyl)(3-tert-butyldimethylsilyl-5-methyl-2-phenoxy)titanium dichloride, isopropylidene(tert-butylcyclopentadienyl)(3-trimethylsilyl-5-methyl-2-phenoxy)titanium dichloride, isopropylidene(tert-butylcyclopentadienyl)(3-tert-butyl-5-methoxy-2-phenoxy)titanium dichloride, isopropylidene(tert-butylcyclopentadienyl)(3-tert-butyl-5-chloro-2-phenoxy)titanium dichloride, isopropylidene(tetramethylcyclopentadienyl)(3,5-dimethyl-2-phenoxy)titanium dichloride, isopropylidene(tetramethylcyclopentadienyl)(3-tert-butyl-2-phenoxy)titanium dichloride, isopropylidene(tetramethylcyclopentadienyl)(3-tert-butyl-5-methyl-2-phenoxy)titanium dichloride, isopropylidene(tetramethylcyclopentadienyl)(3-phenyl-2-phenoxy)titanium dichloride, isopropylidene(tetramethylcyclopentadienyl)(3-tert-butyldimethylsilyl-5-methyl-2-phenoxy)titanium dichloride, isopropylidene(tetramethylcyclopentadienyl)(3-trimethylsilyl-5-methyl-2-phenoxy)titanium dichloride, isopropylidene(tetramethylcyclopentadienyl)(3-tert-butyl-5-methoxy-2-phenoxy)titanium dichloride, isopropylidene(tetramethylcyclopentadienyl)(3-tert-butyl-5-chloro-2-phenoxy)titanium dichloride, isopropylidene(trimethylsilylcyclopentadienyl)(3,5-dimethyl-2-phenoxy)titanium dichloride, isopropylidene(trimethylsilylcyclopentadienyl)(3-tert-butyl-2-phenoxy)titanium dichloride, isopropylidene(trimethylsilylcyclopentadienyl)(3-tert-butyl-5-methyl-2-phenoxy)titanium dichloride, isopropylidene(trimethylsilylcyclopentadienyl)(3-phenyl-2-phenoxy)titanium dichloride, isopropylidene(trimethylsilylcyclopentadienyl)(3-tert-butyldimethylsilyl-5-methyl-2-phenoxy)titanium dichloride, isopropylidene(trimethylsilylcyclopentadienyl)(3-trimethylsilyl-5-methyl-2-phenoxy)titanium dichloride, isopropylidene(trimethylsilylcyclopentadienyl)(3-tert-butyl-5-methoxy-2-phenoxy)titanium dichloride, isopropylidene(trimethylsilylcyclopentadienyl)(3-tert-butyl-5-chloro-2-phenoxy)titanium dichloride, isopropylidene(fluorenyl)(3,5-dimethyl-2-phenoxy)titanium dichloride, isopropylidene(fluorenyl)(3-tert-butyl-2-phenoxy)titanium dichloride, isopropylidene(fluorenyl)(3-tert-butyl-5-methyl-2-phenoxy) titanium dichloride, isopropylidene(fluorenyl)(3-phenyl-2-phenoxy)titanium dichloride, isopropylidene(fluorenyl)(3-tert-butyldimethylsilyl-5-methyl-2-phenoxy)titanium dichloride, isopropylidene(fluorenyl)(3-trimethylsilyl-5-methyl-2-phenoxy)titanium dichloride, isopropylidene(fluorenyl)(3-tert-butyl-5-methoxy-2-phenoxy) titanium dichloride, isopropylidene(fluorenyl)(3-tert-butyl-5-chloro-2-phenoxy) titanium dichloride, diphenylmethylene(cyclopentadienyl)(3,5-dimethyl-2-phenoxy) titanium dichloride, diphenylmethylene(cyclopentadienyl)(3-tert-butyl-2-phenoxy) titanium dichloride, diphenylmethylene(cyclopentadienyl)(3-tert-butyl-5-methyl-2-phenoxy)titanium dichloride, diphenylmethylene(cyclopentadienyl)(3-phenyl-2-phenoxy) titanium dichloride, diphenylmethylene(cyclopentadienyl)(3-tert-butyldimethylsilyl-5-methyl-2-phenoxy)titanium dichloride, diphenylmethylene(cyclopentadienyl)(3-trimethylsilyl-5-methyl-2-phenoxy)titanium dichloride, diphenylmethylene(cyclopentadienyl)(3-tert-butyl-5-methoxy-2-phenoxy)titanium dichloride, diphenylmethylene(cyclopentadienyl)(3-tert-butyl-5-chloro-2-phenoxy)titanium dichloride, diphenylmethylene(methylcyclopentadienyl)(3,5-dimethyl-2-phenoxy)titanium dichloride, diphenylmethylene(methylcyclopentadienyl)(3-tert-butyl-2-phenoxy)titanium dichloride, diphenylmethylene(methylcyclopentadienyl)(3-tert-butyl-5-methyl-2-phenoxy)titanium dichloride, diphenylmethylene(methylcyclopentadienyl)(3-phenyl-2-phenoxy)titanium dichloride, diphenylmethylene(methylcyclopentadienyl)(3-tert-butyldimethylsilyl-5-methyl-2-phenoxy)titanium dichloride, diphenylmethylene(methylcyclopentadienyl)(3-trimethylsilyl-5-methyl-2-phenoxy)titanium dichloride, diphenylmethylene(methylcyclopentadienyl)(3-tert-butyl-5-methoxy-2-phenoxy)titanium dichloride, diphenylmethylene(methylcyclopentadienyl)(3-tert-butyl-5-chloro-2-phenoxy)titanium dichloride, diphenylmethylene(tert-butylcyclopentadienyl)(3,5-dimethyl-2-phenoxy)titanium dichloride, diphenylmethylene(tert-butylcyclopentadienyl)(3-tert-butyl-2-phenoxy)titanium dichloride, diphenylmethylene(tert-butylcyclopentadienyl)(3-tert-butyl-5-methyl-2-phenoxy)titanium dichloride, diphenylmethylene(tert-butylcyclopentadienyl)(3-phenyl-2-phenoxy)titanium dichloride, diphenylmethylene(tert-butylcyclopentadienyl)(3-tert-butyldimethylsilyl-5-methyl-2-phenoxy)titanium dichloride, diphenylmethylene(tert-butylcyclopentadienyl)(3-trimethylsilyl-5-methyl-2-phenoxy)titanium dichloride, diphenylmethylene(tert-butylcyclopentadienyl)(3-tert-butyl-5-methoxy-2-phenoxy)titanium dichloride, diphenylmethylene(tert-butylcyclopentadienyl)(3-tert-butyl-5-chloro-2-phenoxy)titanium dichloride, diphenylmethylene(tetramethylcyclopentadienyl)(3,5-dimethyl-2-phenoxy)titanium dichloride, diphenylmethylene(tetramethylcyclopentadienyl)(3-tert-butyl-2-phenoxy)titanium dichloride, diphenylmethylene(tetramethylcyclopentadienyl)(3-tert-butyl-5-methyl-2-phenoxy)titanium dichloride, diphenylmethylene(tetramethylcyclopentadienyl)(3-phenyl-2-phenoxy)titanium dichloride, diphenylmethylene(tetramethylcyclopentadienyl)(3-tert-butyldimethylsilyl-5-methyl-2-phenoxy)titanium dichloride, diphenylmethylene(tetramethylcyclopentadienyl)(3-trimethylsilyl-5-methyl-2-phenoxy)titanium dichloride, diphenylmethylene(tetramethylcyclopentadienyl)(3-tert-butyl-5-methoxy-2-phenoxy)titanium dichloride, diphenylmethylene(tetramethylcyclopentadienyl)(3-tert-butyl-5-chloro-2-phenoxy)titanium dichloride, diphenylmethylene(trimethylsilylcyclopentadienyl)(3,5-dimethyl-2-phenoxy)titanium dichloride, diphenylmethylene(trimethylsilylcyclopentadienyl)(3-tert-butyl-2-phenoxy)titanium dichloride, diphenylmethylene(trimethylsilylcyclopentadienyl)(3-tert-butyl-5-methyl-2-phenoxy)titanium dichloride, diphenylmethylene(trimethylsilylcyclopentadienyl)(3-phenyl-2-phenoxy)titanium dichloride, diphenylmethylene(trimethylsilylcyclopentadienyl)(3-tert-butyldimethylsilyl-5-methyl-2-phenoxy)titanium dichloride, diphenylmethylene(trimethylsilylcyclopentadienyl)(3-trimethylsilyl-5-methyl-2-phenoxy)titanium dichloride, diphenylmethylene(trimethylsilylcyclopentadienyl)(3-tert-butyl-5-methoxy-2-phenoxy)titanium dichloride, diphenylmethylene(trimethylsilylcyclopentadienyl)(3-tert-butyl-5-chloro-2-phenoxy)titanium dichloride, diphenylmethylene(fluorenyl)(3,5-dimethyl-2-phenoxy) titanium dichloride, diphenylmethylene(fluorenyl)(3-tert-butyl-2-phenoxy) titanium dichloride, diphenylmethylene(fluorenyl)(3-tert-butyl-5-methyl-2-phenoxy)titanium dichloride, diphenylmethylene(fluorenyl)(3-phenyl-2-phenoxy)titanium dichloride, diphenylmethylene(fluorenyl)(3-tert-butyldimethylsilyl-5-methyl-2-phenoxy)titanium dichloride, diphenylmethylene(fluorenyl)(3-trimethylsilyl-5-methyl-2-phenoxy)titanium dichloride, diphenylmethylene(fluorenyl)(3-tert-butyl-5-methoxy-2-phenoxy)titanium dichloride, diphenylmethylene(fluorenyl)(3-tert-butyl-5-chloro-2-phenoxy)titanium dichloride, dimethylsilylene(cyclopentadienyl)(2-phenoxy)titanium dichloride, dimethylsilylene(cyclopentadienyl)(3-methyl-2-phenoxy) titanium dichloride, dimethylsilylene(cyclopentadienyl)(3,5-dimethyl-2-phenoxy) titanium dichloride, dimethylsilylene(cyclopentadienyl)(3-tert-butyl-2-phenoxy) titanium dichloride, dimethylsilylene(cyclopentadienyl)(3-tert-butyl-5-methyl-2-phenoxy)titanium dichloride, dimethylsilylene(cyclopentadienyl)(3,5-di-tert-butyl-2-phenoxy)titanium dichloride, dimethylsilylene(cyclopentadienyl)(5-methyl-3-phenyl-2-phenoxy)titanium dichloride, dimethylsilylene(cyclopentadienyl)(3-tert-butyldimethylsilyl-5-methyl-2-phenoxy)titanium dichloride, dimethylsilylene(cyclopentadienyl)(5-methyl-3-trimethylsilyl-2-phenoxy)titanium dichloride, dimethylsilylene(cyclopentadienyl)(3-tert-butyl-5-methoxy-2-phenoxy)titanium dichloride, dimethylsilylene(cyclopentadienyl)(3-tert-butyl-5-chloro-2-phenoxy)titanium dichloride, dimethylsilylene(cyclopentadienyl)(3,5-diamyl-2-phenoxy) titanium dichloride, dimethylsilylene(methylcyclopentadienyl)(2-phenoxy)titanium dichloride, dimethylsilylene(methylcyclopentadienyl)(3-methyl-2-phenoxy)titanium dichloride, dimethylsilylene(methylcyclopentadienyl)(3,5-dimethyl-2-phenoxy)titanium dichloride, dimethylsilylene(methylcyclopentadienyl)(3-tert-butyl-2-phenoxy)titanium dichloride, dimethylsilylene(methylcyclopentadienyl)(3-tert-butyl-5-methyl-2-phenoxy)titanium dichloride, dimethylsilylene(methylcyclopentadienyl)(3,5-di-tert-butyl-2-phenoxy)titanium dichloride, dimethylsilylene(methylcyclopentadienyl)(5-methyl-3-phenyl-2-phenoxy)titanium dichloride, dimethylsilylene(methylcyclopentadienyl)(3-tert-butyldimethylsilyl-5-methyl-2-phenoxy)titanium dichloride, dimethylsilylene(methylcyclopentadienyl)(5-methyl-3-trimethylsilyl-2-phenoxy)titanium dichloride, dimethylsilylene(methylcyclopentadienyl)(3-tert-butyl-5-methoxy-2-phenoxy)titanium dichloride, dimethylsilylene(methylcyclopentadienyl)(3-tert-butyl-5-chloro-2-phenoxy)titanium dichloride, dimethylsilylene(methylcyclopentadienyl)(3,5-diamyl-2-phenoxy)titanium dichloride, dimethylsilylene(n-butylcyclopentadienyl)(2-phenoxy) titanium dichloride, dimethylsilylene(n-butylcyclopentadienyl)(3-methyl-2-phenoxy)titanium dichloride, dimethylsilylene(n-butylcyclopentadienyl)(3,5-dimethyl-2-phenoxy)titanium dichloride, dimethylsilylene(n-butylcyclopentadienyl)(3-tert-butyl-2-phenoxy)titanium dichloride, dimethylsilylene(n-butylcyclopentadienyl)(3-tert-butyl-5-methyl-2-phenoxy)titanium dichloride, dimethylsilylene(n-butylcyclopentadienyl)(3,5-di-tert-butyl-2-phenoxy)titanium dichloride, dimethylsilylene(n-butylcyclopentadienyl)(5-methyl-3-phenyl-2-phenoxy)titanium dichloride, dimethylsilylene(n-butylcyclopentadienyl)(3-tert-butyldimethylsilyl-5-methyl-2-phenoxy)titanium dichloride, dimethylsilylene(n-butylcyclopentadienyl)(5-methyl-3-trimethylsilyl-2-phenoxy)titanium dichloride, dimethylsilylene(n-butylcyclopentadienyl)(3-tert-butyl-5-methoxy-2-phenoxy)titanium dichloride, dimethylsilylene(n-butylcyclopentadienyl)(3-tert-butyl-5-chloro-2-phenoxy)titanium dichloride, dimethylsilylene(n-butylcyclopentadienyl)(3,5-diamyl-2-phenoxy)titanium dichloride, dimethylsilylene(tert-butylcyclopentadienyl)(2-phenoxy) titanium dichloride, dimethylsilylene(tert-butylcyclopentadienyl)(3-methyl-2-phenoxy)titanium dichloride, dimethylsilylene(tert-butylcyclopentadienyl)(3,5-dimethyl-2-phenoxy)titanium dichloride, dimethylsilylene(tert-butylcyclopentadienyl)(3-tert-butyl-2-phenoxy)titanium dichloride, dimethylsilylene(tert-butylcyclopentadienyl)(3-tert-butyl-5-m ethyl-2-phenoxy)titanium dichloride, dimethylsilylene(tert-butylcyclopentadienyl)(3,5-di-tert-butyl-2-phenoxy)titanium dichloride, dimethylsilylene(tert-butylcyclopentadienyl)(5-methyl-3-phenyl-2-phenoxy)titanium dichloride, dimethylsilylene(tert-butylcyclopentadienyl)(3-tert-butyldimethylsilyl-5-methyl-2-phenoxy)titanium dichloride, dimethylsilylene(tert-butylcyclopentadienyl)(5-methyl-3-trimethylsilyl-2-phenoxy)titanium dichloride, dimethylsilylene(tert-butylcyclopentadienyl)(3-tert-butyl-5-m ethoxy-2-phenoxy)titanium dichloride, dimethylsilylene(tert-butylcyclopentadienyl)(3-tert-butyl-5-chloro-2-phenoxy)titanium dichloride, dimethylsilylene(tert-butylcyclopentadienyl)(3,5-diamyl-2-phenoxy)titanium dichloride, dimethylsilylene(tetramethylcyclopentadienyl)(2-phenoxy) titanium dichloride, dimethylsilylene(tetramethylcyclopentadienyl)(3-methyl-2-phenoxy)titanium dichloride, dimethylsilylene(tetramethylcyclopentadienyl)(3,5-dimethyl-2-phenoxy)titanium dichloride, dimethylsilylene(tetramethylcyclopentadienyl)(3-tert-butyl-2-phenoxy)titanium dichloride, dimethylsilylene(tetramethylcyclopentadienyl)(3-tert-butyl-5-methyl-2-phenoxy)titanium dichloride, dimethylsilylene(tetramethylcyclopentadienyl)(3,5-di-tert-butyl-2-phenoxy)titanium dichloride, dimethylsilylene(tetramethylcyclopentadienyl)(5-methyl-3-phenyl-2-phenoxy)titanium dichloride, dimethylsilylene(tetramethylcyclopentadienyl)(3-tert-butyldimethylsilyl-5-methyl-2-phenoxy)titanium dichloride, dimethylsilylene(tetramethylcyclopentadienyl)(5-methyl-3-trimethylsilyl-2-phenoxy)titanium dichloride, dimethylsilylene(tetramethylcyclopentadienyl)(3-tert-butyl-5-methoxy-2-phenoxy)titanium dichloride, dimethylsilylene(tetramethylcyclopentadienyl)(3-tert-butyl-5-chloro-2-phenoxy)titanium dichloride, dimethylsilylene(tetramethylcyclopentadienyl)(3,5-diamyl-2-phenoxy)titanium dichloride, dimethylsilylene(trimethylsilylcyclopentadienyl)(2-phenoxy) titanium dichloride, dimethylsilylene(trimethylsilylcyclopentadienyl)(3-methyl-2-phenoxy)titanium dichloride, dimethylsilylene(trimethylsilylcyclopentadienyl)(3,5-dimethyl-2-phenoxy)titanium dichloride, dimethylsilylene(trimethylsilylcyclopentadienyl)(3-tert-butyl-2-phenoxy)titanium dichloride, dimethylsilylene(trimethylsilylcyclopentadienyl)(3-tert-butyl-5-methyl-2-phenoxy)titanium dichloride, dimethylsilylene(trimethylsilylcyclopentadienyl)(3,5-di-tert-butyl-2-phenoxy)titanium dichloride, dimethylsilylene(trimethylsilylcyclopentadienyl)(5-methyl-3-phenyl-2-phenoxy)titanium dichloride, dimethylsilylene(trimethylsilylcyclopentadienyl)(3-tert-butyldimethylsilyl-5-methyl-2-phenoxy)titanium dichloride, dimethylsilylene(trimethylsilylcyclopentadienyl)(5-methyl-3-trimethylsilyl-2-phenoxy)titanium dichloride, dimethylsilylene(trimethylsilylcyclopentadienyl)(3-tert-butyl-5-methoxy-2-phenoxy)titanium dichloride, dimethylsilylene(trimethylsilylcyclopentadienyl)(3-tert-butyl-5-chloro-2-phenoxy)titanium dichloride, dimethylsilylene(trimethylsilylcyclopentadienyl)(3,5-diamyl-2-phenoxy)titanium dichloride, dimethylsilylene(indenyl)(2-phenoxy)titanium dichloride, dimethylsilylene(indenyl)(3-methyl-2-phenoxy)titanium dichloride, dimethylsilylene(indenyl)(3,5-dimethyl-2-phenoxy)titanium dichloride, dimethylsilylene(indenyl)(3-tert-butyl-2-phenoxy)titanium dichloride, dimethylsilylene(indenyl)(3-tert-butyl-5-methyl-2-phenoxy) titanium dichloride, dimethylsilylene(indenyl)(3,5-di-tert-butyl-2-phenoxy) titanium dichloride, dimethylsilylene(indenyl)(5-methyl-3-phenyl-2-phenoxy)titanium dichloride, dimethylsilylene(indenyl)(3-tert-butyldimethylsilyl-5-methyl-2-phenoxy)titanium dichloride, dimethylsilylene(indenyl)(5-methyl-3-trimethylsilyl-2-phenoxy)titanium dichloride, dimethylsilylene(indenyl)(3-tert-butyl-5-methoxy-2-phenoxy) titanium dichloride, dimethylsilylene(indenyl)(3-tert-butyl-5-chloro-2-phenoxy) titanium dichloride, dimethylsilylene(indenyl)(3,5-diamyl-2-phenoxy)titanium dichloride, dimethylsilylene(fluorenyl)(2-phenoxy)titanium dichloride, dimethylsilylene(fluorenyl)(3-methyl-2-phenoxy)titanium dichloride, dimethylsilylene(fluorenyl)(3,5-dimethyl-2-phenoxy)titanium dichloride, dimethylsilylene(fluorenyl)(3-tert-butyl-2-phenoxy)titanium dichloride, dimethylsilylene(fluorenyl)(3-tert-butyl-5-methyl-2-phenoxy)titanium dichloride, dimethylsilylene(fluorenyl)(3,5-di-tert-butyl-2-phenoxy) titanium dichloride, dimethylsilylene(fluorenyl)(5-methyl-3-phenyl-2-phenoxy)titanium dichloride, dimethylsilylene(fluorenyl)(3-tert-butyldimethylsilyl-5-methyl-2-phenoxy)titanium dichloride, dimethylsilylene(fluorenyl)(5-methyl-3-trimethylsilyl-2-phenoxy)titanium dichloride, dimethylsilylene(fluorenyl)(3-tert-butyl-5-methoxy-2-phenoxy)titanium dichloride, dimethylsilylene(fluorenyl)(3-tert-butyl-5-chloro-2-phenoxy)titanium dichloride, dimethylsilylene(fluorenyl)(3,5-diamyl-2-phenoxy)titanium dichloride, and dimethylsilylene(tetramethylcyclopentadienyl)(1-naphthoxy-2-yl)titanium dichloride; compounds obtained by replacing the term “(2-phenoxy)” of those compounds with the term “(3-phenyl-2-phenoxy)”, “(3-trimethylsilyl-2-phenoxy)” or “(3-tert-butyldimethylsilyl-2-phenoxy)”; compounds obtained by replacing the term “dimethylsilylene” of those compounds with the term “diethylsilylene”, “diphenylsilylene” or “dimethoxysilylene”; and compounds obtained by replacing the term “dichloride” of those compounds with the term “difluoride”, “dibromide”, “diiodide”, “dimethyl”, “diethyl”, “diisopropyl”, “bis(dimethylamido)”, “bis(diethylamido)”, “dimethoxide”, “diethoxide”, “di-n-butoxide” or “diisopropoxide”.

Further examples of the transition metal compound represented by formula (4), wherein M¹ is a titanium atom, are (tert-butylamido)tetramethylcyclopentadienyl-1,2-ethanediyltitanium dichloride, (tert-butylamido)tetramethylcyclopentadienyl-1,2-ethanediyltitanium dimethyl, (tert-butylamido)tetramethylcyclopentadienyl-1,2-ethanediyltitanium dibenzyl, (methylamido)tetramethylcyclopentadienyl-1,2-ethanediyltitanium dichloride, (ethylamido)tetramethylcyclopentadienyl-1,2-ethanediyltitanium dichloride, (tert-butylamido)tetramethylcyclopentadienyl dimethylsilanetitanium dichloride, (tert-butylamido)tetramethylcyclopentadienyl dimethylsilanetitanium dimethyl, (tert-butylamido)tetramethylcyclopentadienyl dimethylsilanetitanium dibenzyl, (benzylamido)tetramethylcyclopentadienyl dimethylsilanetitanium dichloride, (phenylphosphido)tetramethylcyclopentadienyl dimethylsilanetitanium dibenzyl, (tert-butylamido)indenyl-1,2-ethanediyltitanium dichloride, (tert-butylamido)indenyl-1,2-ethanediyltitanium dimethyl, (tert-butylamido)tetrahydroindenyl-1,2-ethanediyl titanium dichloride, (tert-butylamido)tetrahydroindenyl-1,2-ethanediyl titanium dimethyl, (tert-butylamido)fluorenyl-1,2-ethanediyltitanium dichloride, (tert-butylamido)fluorenyl-1,2-ethanediyltitanium dimethyl, (tert-butylamido)indenyldimethylsilanetitanium dichloride, (tert-butylamido)indenyldimethylsilanetitanium dimethyl, (tert-butylamido)tetrahydroindenyldimethylsilane titanium dichloride, (tert-butylamido)tetrahydroindenyldimethylsilane titanium dimethyl, (tert-butylamido)fluorenyldimethylsilanetitanium dichloride, (tert-butylamido)fluorenyldimethylsilanetitanium dimethyl, (dimethylaminomethyl)tetramethylcyclopentadienyl titanium(III) dichloride, (dimethylaminoethyl)tetramethylcyclopentadienyl titanium(III) dichloride, (dimethylaminopropyl)tetramethylcyclopentadienyl titanium(III) dichloride, (N-pyrrolidinylethyl)tetramethylcyclopentadienyl titanium dichloride, (B-dimethylaminoborabenzene)cyclopentadienylzirconium dichloride, cyclopentadienyl(9-mesitylboraanthracenyl)zirconium dichloride, 2,2′-thiobis(4-methyl-6-tert-butylphenoxy)titanium dichloride, 2,2′-thiobis[4-methyl-6-(1-methylethyl)phenoxy]titanium dichloride, 2,2′-thiobis[4,6-dimethylphenoxy]titanium dichloride, 2,2′-methylenebis(4-methyl-6-tert-butylphenoxy) titanium dichloride, 2,2′-ethylenebis(4-methyl-6-tert-butylphenoxy)titanium dichloride, 2,2′-sulfinylbis(4-methyl-6-tert-butylphenoxy) titanium dichloride, 2,2′-(4,4′,6,6′-tetra-tert-butyl-1,1′-biphenoxy)titanium dichloride, 2,2′-thiobis[4-methyl-6-tert-butylphenoxy]titanium diisopropoxide, 2,2′-methylenebis(4-methyl-6-tert-butylphenoxy)titanium diisopropoxide, 2,2′-ethylenebis(4-methyl-6-tert-butylphenoxy)titanium diisopropoxide, 2,2′-sulfinylbis(4-methyl-6-tert-butylphenoxy)titanium diisopropoxide, (di-tert-butyl-1,3-propanediamido)titanium dichloride, (dicyclohexyl-1,3-propanediamido)titanium dichloride, [bis(trimethylsilyl)-1,3-propanediamido]titanium dichloride, [bis(tert-butyldimethylsilyl)-1,3-propanediamido]titanium dichloride, [bis(2,6-dimethylphenyl)-1,3-propanediamido]titanium dichloride, [bis(2,6-diisopropylphenyl)-1,3-propanediamido]titanium dichloride, [bis(2,6-di-tert-butylphenyl)-1,3-propanediamido]titanium dichloride, [bis(triisopropylsilyl)naphthalenediamido]titanium dichloride, [bis(trimethylsilyl)naphthalenediamido]titanium dichloride, [bis(tert-butyldimethylsilyl)naphthalenediamido]titanium dichloride, [bis(tert-butyldimethylsilyl)naphthalenediamido]titanium dibromide, [hydrotris(3,5-dimethylpyrazolyl)borate]titanium trichloride, [hydrotris(3,5-dimethylpyrazolyl)borate]titanium tribromide, [hydrotris(3,5-dimethylpyrazolyl)borate]titanium triiodide, [hydrotris(3,5-diethylpyrazolyl)borate]titanium trichloride, [hydrotris(3,5-diethylpyrazolyl)borate]titanium tribromide, [hydrotris(3,5-diethylpyrazolyl)borate]titanium triiodide, [hydrotris(3,5-di-tert-butylpyrazolyl)borate]titanium trichloride, [hydrotris(3,5-di-tert-butylpyrazolyl)borate]titanium tribromide, [hydrotris(3,5-di-tert-butylpyrazolyl)borate]titanium triiodide, [tris(3,5-dimethylpyrazolyl)methyl]titanium trichloride, [tris(3,5-dimethylpyrazolyl)methyl]titanium tribromide, [tris(3,5-dimethylpyrazolyl)methyl]titanium triiodide, [tris(3,5-diethylpyrazolyl)methyl]titanium trichloride, [tris(3,5-diethylpyrazolyl)methyl]titanium tribromide, [tris(3,5-diethylpyrazolyl)methyl]titanium triiodide, [tris(3,5-di-tert-butylpyrazolyl)methyl]titanium trichloride, [tris(3,5-di-tert-butylpyrazolyl)methyl]titanium tribromide, [tris(3,5-di-tert-butylpyrazolyl)methyl]titanium triiodide, μ-oxobis[isopropylidene(cyclopentadienyl)(2-phenoxy) titanium chloride], μ-oxobis[isopropylidene (cyclopentadienyl)(2-phenoxy)titanium methoxide], μ-oxobis[isopropylidene(cyclopentadienyl)(3-tert-butyl-5-methyl-2-phenoxy)titanium chloride], μ-oxobis[isopropylidene(cyclopentadienyl)(3-tert-butyl-5-methyl-2-phenoxy)titanium methoxide], μ-oxobis[isopropylidene (methylcyclopentadienyl)(2-phenoxy)titanium chloride], μ-oxobis[isopropylidene(methylcyclopentadienyl)(2-phenoxy) titanium methoxide], μ-oxobis[isopropylidene (methylcyclopentadienyl)(3-tert-butyl-5-methyl-2-phenoxy) titanium chloride], μ-oxobis[isopropylidene (methylcyclopentadienyl)(3-tert-butyl-5-methyl-2-phenoxy) titanium methoxide], μ-oxobis[isopropylidene (tetramethylcyclopentadienyl)(2-phenoxy)titanium chloride], μ-oxobis[isopropylidene(tetramethylcyclopentadienyl) (2-phenoxy)titanium methoxide], μ-oxobis[isopropylidene (tetramethylcyclopentadienyl)(3-tert-butyl-5-methyl-2-phenoxy)titanium chloride], μ-oxobis[isopropylidene (tetramethylcyclopentadienyl)(3-tert-butyl-5-methyl-2-phenoxy)titanium methoxide], μ-oxobis[dimethylsilylene (cyclopentadienyl)(2-phenoxy)titanium chloride], μ-oxobis[dimethylsilylene(cyclopentadienyl)(2-phenoxy) titanium methoxide], μ-oxobis[dimethylsilylene (cyclopentadienyl)(3-tert-butyl-5-methyl-2-phenoxy)titanium chloride], μ-oxobis[dimethylsilylene(cyclopentadienyl) (3-tert-butyl-5-methyl-2-phenoxy)titanium methoxide], μ-oxobis[dimethylsilylene(methylcyclopentadienyl)(2-phenoxy) titanium chloride], μ-oxobis[dimethylsilylene (methylcyclopentadienyl)(2-phenoxy)titanium methoxide], μ-oxobis[dimethylsilylene(methylcyclopentadienyl) (3-tert-butyl-5-methyl-2-phenoxy)titanium chloride], μ-oxobis[dimethylsilylene(methylcyclopentadienyl) (3-tert-butyl-5-methyl-2-phenoxy)titanium methoxide], μ-oxobis[dimethylsilylene(tetramethylcyclopentadienyl) (2-phenoxy)titanium chloride], μ-oxobis[dimethylsilylene (tetramethylcyclopentadienyl) (2-phenoxy)titaniummethoxide], μ-oxobis[dimethylsilylene(tetramethylcyclopentadienyl) (3-tert-butyl-5-methyl-2-phenoxy)titanium chloride], μ-oxobis[dimethylsilylene(tetramethylcyclopentadienyl) (3-tert-butyl-5-methyl-2-phenoxy)titanium methoxide], di-μ-oxobis[isopropylidene(cyclopentadienyl)(2-phenoxy) titanium], di-μ-oxobis[isopropylidene(cyclopentadienyl) (3-tert-butyl-5-methyl-2-phenoxy)titanium], di-μ-oxobis[isopropylidene(methylcyclopentadienyl)(2-phenoxy)titanium], di-μ-oxobis[isopropylidene(methylcyclopentadienyl)(3-tert-butyl-5-methyl-2-phenoxy)titanium], di-μ-oxobis[isopropylidene(tetramethylcyclopentadienyl)(2-phenoxy) titanium], di-μ-oxobis[isopropylidene (tetramethylcyclopentadienyl)(3-tert-butyl-5-methyl-2-phenoxy)titanium], di-μ-oxobis[dimethylsilylene (cyclopentadienyl)(2-phenoxy)titanium], di-μ-oxobis[dimethylsilylene(cyclopentadienyl)(3-tert-butyl-5-methyl-2-phenoxy)titanium], di-μ-oxobis[dimethylsilylene (methylcyclopentadienyl)(2-phenoxy)titanium], di-μ-oxobis[dimethylsilylene(methylcyclopentadienyl)(3-tert-butyl-5-methyl-2-phenoxy)titanium], di-μ-oxobis[dimethylsilylene (tetramethylcyclopentadienyl)(2-phenoxy)titanium], and di-μ-oxobis[dimethylsilylene(tetramethylcyclopentadienyl) (3-tert-butyl-5-methyl-2-phenoxy)titanium].

Examples of the transition metal compound represented by formula (4), wherein M¹ is a zirconium atom or a hafnium atom, are compounds obtained by replacing the term “titanium” of the above-exemplified titanium compounds with the term “zirconium” or “hafnium”.

Examples of the transition metal compound represented by formula (4), wherein M¹ is a vanadium atom, are vanadium acetylacetonate, vanadium tetrachloride and vanadium oxy trichloride.

An example of the transition metal compound represented by formula (4), wherein M¹ is a samarium atom, is bis(pentamethylcyclopentadienyl)samarium methyltetrahydrofuran.

An example of the transition metal compound represented by formula (4), wherein M¹ is an ytterbium atom, is bis(pentamethylcyclopentadienyl)ytterbium methyltetrahydrofuran.

Examples of the transition metal compound represented by formula (4), wherein M¹ is a palladium atom, are 2,2′-methylenebis[(4R)-4-phenyl-5,5′-dimethyloxazoline]palladium dichloride, 2,2′-methylenebis[(4R)-4-phenyl-5,5′-dimethyloxazoline]palladium dibromide, 2,2′-methylenebis[(4R)-4-phenyl-5,5′-diethyloxazoline]palladium dichloride, 2,2′-methylenebis[(4R)-4-phenyl-5,5′-diethyloxazoline]palladium dibromide, 2,2′-methylenebis[(4R)-4-phenyl-5,5′-di-n-propyloxazoline]palladium dichloride, 2,2′-methylenebis[(4R)-4-phenyl-5,5′-di-n-propyloxazoline]palladium dibromide, 2,2′-methylenebis[(4R)-4-phenyl-5,5′-diisopropyloxazoline]palladium dichloride, 2,2′-methylenebis[(4R)-4-phenyl-5,5′-diisopropyloxazoline]palladium dibromide, 2,2′-methylenebis[(4R)-4-phenyl-5,5′-dicyclohexyloxazoline]palladium dichloride, 2,2′-methylenebis[(4R)-4-phenyl-5,5′-dicyclohexyloxazoline]palladium dibromide, 2,2′-methylenebis[(4R)-4-phenyl-5,5′-dimethoxyoxazoline]palladium dichloride, 2,2′-methylenebis[(4R)-4-phenyl-5,5′-dimethoxyoxazoline]palladium dibromide, 2,2′-methylenebis[(4R)-4-phenyl-5,5′-diethoxyoxazoline]palladium dichloride, 2,2′-methylenebis[(4R)-4-phenyl-5,5′-diethoxyoxazoline]palladium dibromide, 2,2′-methylenebis[(4R)-4-phenyl-5,5′-diphenyloxazoline]palladium dichloride, 2,2′-methylenebis[(4R)-4-phenyl-5,5′-diphenyloxazoline]palladium dibromide, methylenebis[(4R)-4-methyl-5,5′-di-(2-methylphenyl)oxazoline]palladium dibromide, methylenebis[(4R)-4-methyl-5,5′-di-(3-methylphenyl) oxazoline]palladium dibromide, methylenebis[(4R)-4-methyl-5,5′-di-(4-methylphenyl)oxazoline]palladium dibromide, methylenebis[(4R)-4-methyl-5,5′-di-(2-methoxyphenyl) oxazoline]palladium dibromide, methylenebis[(4R)-4-methyl-5,5′-di-(3-methoxyphenyl)oxazoline]palladium dibromide, methylenebis[(4R)-4-methyl-5,5′-di-(4-methoxyphenyl) oxazoline]palladium dibromide, methylenebis[spiro{(4R)-4-methyloxazoline-5,1′-cyclobutane}]palladium dibromide, methylenebis[spiro{(4R)-4-methyloxazoline-5,1′-cyclopentane}]palladium dibromide, methylenebis[spiro{(4R)-4-methyloxazoline-5,1′-cyclohexane}]palladium dibromide, methylenebis[spiro{(4R)-4-methyloxazoline-5,1′-cycloheptane}]palladium dibromide, 2,2′-methylenebis[(4R)-4-isopropyl-5,5′-dimethyloxazoline]palladium dibromide, 2,2′-methylenebis[(4R)-4-isopropyl-5,5′-diethyloxazoline]palladium dibromide, 2,2′-methylenebis[(4R)-4-isopropyl-5,5′-di-n-propyloxazoline]palladium dibromide, methylenebis[(4R)-4-isopropyl-5,5′-diisopropyloxazoline]palladium dibromide, 2,2′-methylenebis[(4R)-4-isopropyl-5,5′-dicyclohexyloxazoline]palladium dibromide, 2,2′-methylenebis[(4R)-4-isopropyl-5,5′-diphenyloxazoline]palladium dibromide, 2,2′-methylenebis[(4R)-4-isopropyl-5,5′-di-(2-methylphenyl)oxazoline]palladium dibromide, 2,2′-methylenebis[(4R)-4-isopropyl-5,5′-di-(3-methylphenyl)oxazoline]palladium dibromide, 2,2′-methylenebis[(4R)-4-isopropyl-5,5′-di-(4-methylphenyl) oxazoline]palladium dibromide, 2,2′-methylenebis[(4R)-4-isopropyl-5,5′-di-(2-methoxyphenyl)oxazoline]palladium dibromide, 2,2′-methylenebis[(4R)-4-isopropyl-5,5′-di-(3-methoxyphenyl)oxazoline]palladium dibromide, 2,2′-methylenebis[(4R)-4-isopropyl-5,5′-di-(4-methoxyphenyl)oxazoline]palladium dibromide, 2,2′-methylenebis[spiro{(4R)-4-isopropyloxazoline-5,1′-cyclobutane}]palladium dibromide, 2,2′-methylenebis[spiro{(4R)-4-isopropyloxazoline-5,1′-cyclopentane}]palladium dibromide, 2,2′-methylenebis[spiro{(4R)-4-isopropyloxazoline-5,1′-cyclohexane}]palladium dibromide, 2,2′-methylenebis[spiro{(4R)-4-isopropyloxazoline-5,1′-cycloheptane}]palladium dibromide, 2,2′-methylenebis[(4R)-4-isobutyl-5,5′-dimethyloxazoline]palladium dibromide, 2,2′-methylenebis[(4R)-4-isobutyl-5,5′-diethyloxazoline]palladium dibromide, 2,2′-methylenebis[(4R)-4-isobutyl-5,5′-di-n-propyloxazoline]palladium dibromide, 2,2′-methylenebis[(4R)-4-isobutyl-5,5′-diisopropyloxazoline]palladium dibromide, 2,2′-methylenebis[(4R)-4-isobutyl-5,5′-dicyclohexyloxazoline]palladium dibromide, 2,2′-methylenebis[(4R)-4-isobutyl-5,5′-diphenyloxazoline]palladium dibromide, 2,2′-methylenebis[(4R)-4-isobutyl-5,5′-di-(2-methylphenyl)oxazoline]palladium dibromide, 2,2′-methylenebis[(4R)-4-isobutyl-5,5′-di-(3-methylphenyl)oxazoline]palladium dibromide, 2,2′-methylenebis[(4R)-4-isobutyl-5,5′-di-(4-methylphenyl) oxazoline]palladium dibromide, 2,2′-methylenebis[(4R)-4-isobutyl-5,5′-di-(2-methoxyphenyl)oxazoline]palladium dibromide, 2,2′-methylenebis[(4R)-4-isobutyl-5,5′-di-(3-methoxyphenyl)oxazoline]palladium dibromide, 2,2′-methylenebis[(4R)-4-isobutyl-5,5′-di-(4-methoxyphenyl) oxazoline]palladium dibromide, 2,2′-methylenebis[spiro{(4R)-4-isobutyloxazoline-5,1′-cyclobutane}]palladium dibromide, 2,2′-methylenebis[spiro{(4R)-4-isobutyloxazoline-5,1′-cyclopentane}]palladium dibromide, 2,2′-methylenebis[spiro{(4R)-4-isobutyloxazoline-5,1′-cyclohexane}]palladium dibromide, 2,2′-methylenebis[spiro{(4R)-4-isobutyloxazoline-5,1′-cycloheptane}]palladium dibromide, 2,2′-methylenebis[(4R)-4-tert-butyl-5,5′-dimethyloxazoline]palladium dibromide, 2,2′-methylenebis[(4R)-4-tert-butyl-5,5′-diethyloxazoline]palladium dibromide, 2,2′-methylenebis[(4R)-4-tert-butyl-5,5′-di-n-propyloxazoline]palladium dibromide, 2,2′-methylenebis[(4R)-4-tert-butyl-5,5′-diisopropyloxazoline]palladium dibromide, 2,2′-methylenebis[(4R)-4-tert-butyl-5,5′-diphenyloxazoline]palladium dibromide, 2,2′-methylenebis[(4R)-4-tert-butyl-5,5′-dicyclohexyloxazoline]palladium dibromide, 2,2′-methylenebis[(4R)-4-tert-butyl-5,5′-di-(2-methylphenyl)oxazoline]palladium dibromide, 2,2′-methylenebis[(4R)-4-tert-butyl-5,5′-di-(3-methylphenyl)oxazoline]palladium dibromide, 2,2′-methylenebis[(4R)-4-tert-butyl-5,5′-di-(4-methylphenyl)oxazoline]palladium dibromide, 2,2′-methylenebis[(4R)-4-tert-butyl-5,5′-di-(2-methoxyphenyl)oxazoline]palladium dibromide, 2,2′-methylenebis[(4R)-4-tert-butyl-5,5′-di-(3-methoxyphenyl)oxazoline]palladium dibromide, 2,2′-methylenebis[(4R)-4-tert-butyl-5,5′-di-(4-methoxyphenyl)oxazoline]palladium dibromide, 2,2′-methylenebis[spiro{(4R)-4-tert-butyloxazoline-5,1′-cyclobutane}]palladium dibromide, 2,2′-methylenebis[spiro{(4R)-4-tert-butyloxazoline-5,1′-cyclopentane}]palladium dibromide, 2,2′-methylenebis[spiro{(4R)-4-tert-butyloxazoline-5,1′-cyclohexane}]palladium dibromide, 2,2′-methylenebis[spiro{(4R)-4-tert-butyloxazoline-5,1′-cycloheptane}]palladium dibromide, 2,2′-methylenebis[(4R)-4-phenyl-5,5′-dimethyloxazoline]palladium dibromide, 2,2′-methylenebis[(4R)-4-phenyl-5,5′-diethyloxazoline]palladium dibromide, 2,2′-methylenebis[(4R)-4-phenyl-5,5′-di-n-propyloxazoline]palladium dibromide, 2,2′-methylenebis[(4R)-4-phenyl-5,5′-diisopropyloxazoline]palladium dibromide, 2,2′-methylenebis[(4R)-4-phenyl-5,5′-dicyclohexyloxazoline]palladium dibromide, 2,2′-methylenebis[(4R)-4-phenyl-5,5′-diphenyloxazoline]palladium dibromide, 2,2′-methylenebis[(4R)-4-phenyl-5,5′-di-(2-methylphenyl)oxazoline]palladium dibromide, 2,2′-methylenebis[(4R)-4-phenyl-5,5′-di-(3-methylphenyl) oxazoline]palladium dibromide, 2,2′-methylenebis[(4R)-4-phenyl-5,5′-di-(4-methylphenyl)oxazoline]palladium dibromide, 2,2′-methylenebis[(4R)-4-phenyl-5,5′-di-(2-methoxyphenyl)oxazoline]palladium dibromide, 2,2′-methylenebis[(4R)-4-phenyl-5,5′-di-(3-methoxyphenyl) oxazoline]palladium dibromide, 2,2′-methylenebis[(4R)-4-phenyl-5,5′-di-(4-methoxyphenyl)oxazoline]palladium dibromide, 2,2′-methylenebis[spiro{(4R)-4-phenyloxazoline-5,1′-cyclobutane}]palladium dibromide, 2,2′-methylenebis[spiro{(4R)-4-phenyloxazoline-5,1′-cyclopentane}]palladium dibromide, 2,2′-methylenebis[spiro{(4R)-4-phenyloxazoline-5,1′-cyclohexane}]palladium dibromide, 2,2′-methylenebis[spiro{(4R)-4-phenyloxazoline-5,1′-cycloheptane}]palladium dibromide, 2,2′-methylenebis[(4R)-4-benzyl-5,5′-dimethyloxazoline]palladium dibromide, 2,2′-methylenebis[(4R)-4-benzyl-5,5′-diethyloxazoline]palladium dibromide, 2,2′-methylenebis[(4R)-4-benzyl-5,5′-di-n-propyloxazoline]palladium dibromide, 2,2′-methylenebis[(4R)-4-benzyl-5,5′-diisopropyloxazoline]palladium dibromide, 2,2′-methylenebis[(4R)-4-benzyl-5,5′-dicyclohexyloxazoline]palladium dibromide, 2,2′-methylenebis[(4R)-4-benzyl-5,5′-diphenyloxazoline]palladium dibromide, 2,2′-methylenebis[(4R)-4-benzyl-5,5′-di-(2-methylphenyl)oxazoline]palladium dibromide, 2′-methylenebis[(4R)-4-benzyl-5,5′-di-(3-methylphenyl) oxazoline]palladium dibromide, 2,2′-methylenebis[(4R)-4-benzyl-5,5′-di-(4-methylphenyl)oxazoline]palladium dibromide, 2,2′-methylenebis[(4R)-4-benzyl-5,5′-di-(2-methoxyphenyl)oxazoline]palladium dibromide, 2,2′-methylenebis[(4R)-4-benzyl-5,5′-di-(3-methoxyphenyl) oxazoline]palladium dibromide, 2,2′-methylenebis[(4R)-4-benzyl-5,5′-di-(4-methoxyphenyl)oxazoline]palladium dibromide, 2,2′-methylenebis[spiro{(4R)-4-benzyloxazoline-5,1′-cyclobutane}]palladium dibromide, 2,2′-methylenebis[spiro{(4R)-4-benzyloxazoline-5,1′-cyclopentane}]palladium dibromide, 2,2′-methylenebis[spiro{(4R)-4-benzyloxazoline-5,1′-cyclohexane}]palladium dibromide, and 2,2′-methylenebis[spiro{(4R)-4-benzyloxazoline-5,1′-cycloheptane}]palladium dibromide; compounds obtained by replacing the term “(4R)” of the above-exemplified compounds with the term “(4S)”; and antipodes and diasteromers of the above-exemplified compounds.

Further examples of the transition metal compound represented by formula (4), wherein M¹ is a palladium atom, are [hydrotris(3,5-dimethylpyrazolyl)borate]palladium chloride, [hydrotris(3,5-dimethylpyrazolyl)borate]palladium bromide, [hydrotris(3,5-dimethylpyrazolyl)borate]palladium iodide, [hydrotris(3,5-dimethylpyrazolyl)borate]palladium methyl, [hydrotris(3,5-dimethylpyrazolyl)borate]palladium ethyl, [hydrotris(3,5-dimethylpyrazolyl)borate]palladium allyl, [hydrotris(3,5-dimethylpyrazolyl)borate]palladium methallyl, [hydrotris(3,5-diethylpyrazolyl)borate]palladium chloride, [hydrotris(3,5-diethylpyrazolyl)borate]palladium bromide, [hydrotris(3,5-diethylpyrazolyl)borate]palladium iodide, [hydrotris(3,5-diethylpyrazolyl)borate]palladium methyl, [hydrotris(3,5-diethylpyrazolyl)borate]palladium ethyl, [hydrotris(3,5-diethylpyrazolyl)borate]palladium allyl, [hydrotris(3,5-diethylpyrazolyl)borate]palladium methallyl, [hydrotris(3,5-di-tert-butylpyrazolyl)borate]palladium chloride, [hydrotris(3,5-di-tert-butylpyrazolyl)borate]palladium bromide, [hydrotris(3,5-di-tert-butylpyrazolyl)borate]palladium iodide, [hydrotris(3,5-di-tert-butylpyrazolyl)borate]palladium methyl, [hydrotris(3,5-di-tert-butylpyrazolyl)borate]palladium ethyl, [hydrotris(3,5-di-tert-butylpyrazolyl) borate]palladium allyl, [hydrotris(3,5-di-tert-butylpyrazolyl)borate]palladium methallyl, chloro(methyl)[N,N′-(ethane-1,2-diylidene)bis(aniline-κN)]palladium, chloro(methyl)[N,N′-(ethane-1,2-diylidene)bis(2-methylaniline-κN)]palladium, chloro(methyl)[N,N′-(ethane-1,2-diylidene)bis(2-ethylaniline-κN)]palladium, chloro(methyl)[N,N′-(ethane-1,2-diylidene)bis(2-n-propylaniline-κN)]palladium, chloro(methyl)[N,N′-(ethane-1,2-diylidene)bis(2-isopropylaniline-κN)]palladium, chloro(methyl)[N,N′-(ethane-1,2-diylidene)bis(2-n-butylaniline-κN)]palladium, chloro(methyl)[N,N′-(ethane-1,2-diylidene)bis(2-isobutylaniline-κN)]palladium, chloro(methyl)[N,N′-(ethane-1,2-diylidene)bis(2-n-hexylaniline-κN)]palladium, chloro(methyl)[N,N′-(ethane-1,2-diylidene)bis(4-methylaniline-κN)]palladium, chloro(methyl)[N,N′-(ethane-1,2-diylidene)bis(2,6-dimethylaniline-κN)]palladium, chloro(methyl)[N,N′-(ethane-1,2-diylidene)bis(2,6-diethylaniline-κN)]palladium, chloro(methyl)[N,N′-(ethane-1,2-diylidene)bis(2,6-di-n-propylaniline-κN)]palladium, chloro(methyl)[N,N′-(ethane-1,2-diylidene)bis(2,6-diisopropylaniline-κN)]palladium, chloro(methyl)[N,N′-(ethane-1,2-diylidene)bis(2,6-di-n-butylaniline-κN)]palladium, chloro(methyl)[N,N′-(ethane-1,2-diylidene)bis(2,6-diisobutylaniline-κN)]palladium, chloro(methyl)[N,N′-(ethane-1,2-diylidene)bis(2,6-di-n-hexylaniline-κN)]palladium, chloro(methyl)[N,N′-(ethane-1,2-diylidene)bis(2-methyl-6-ethylaniline-κN)]palladium, chloro(methyl)[N,N′-(ethane-1,2-diylidene)bis(2-methyl-6-n-propylaniline-κN)]palladium, chloro(methyl)[N,N′-(ethane-1,2-diylidene)bis(2-methyl-6-isopropylaniline-κN)]palladium, chloro(methyl)[N,N′-(ethane-1,2-diylidene)bis(2-methyl-6-butylaniline-κN)]palladium, chloro(methyl)[N,N′-(ethane-1,2-diylidene)bis(2-ethyl-6-n-propylaniline-κN)]palladium, chloro(methyl)[N,N′-(ethane-1,2-diylidene)bis(2-ethyl-6-isopropylaniline-κN)]palladium, chloro(methyl)[N,N′-(ethane-1,2-diylidene)bis(2-ethyl-6-n-butylaniline-κN)]palladium, chloro(methyl)[N,N′-(ethane-1,2-diylidene)bis(2-n-propyl-6-isopropylaniline-κN)]palladium, chloro(methyl)[N,N′-(ethane-1,2-diylidene)bis(2-n-propyl-6-n-butylaniline-κN)]palladium, chloro(methyl)[N,N′-(ethane-1,2-diylidene)bis(2-isopropyl-6-n-butylaniline-κN)]palladium, chloro(methyl)[N,N′-(ethane-1,2-diylidene)bis(2,4,6-trimethylaniline-κN)]palladium, chloro(methyl)[N,N′-(ethane-1,2-diylidene)bis{2,4-dimethyl-6-(2-methylphenyl)aniline-κN}]palladium, chloro(methyl)[N,N′-(ethane-1,2-diylidene)bis{2,4-dimethyl-6-(2-ethylphenyl)aniline-κN}]palladium, chloro(methyl)[N,N′-(ethane-1,2-diylidene)bis{2,4-dimethyl-6-(2-n-propylphenyl)aniline-κN}]palladium, chloro(methyl)[N,N′-(ethane-1,2-diylidene)bis{2,4-dimethyl-6-(2-isopropylphenyl)aniline-κN}]palladium, chloro(methyl)[N,N′-(ethane-1,2-diylidene)bis{2,4-dimethyl-6-(2,6-dimethylphenyl)aniline-κN}]palladium, chloro(methyl)[N,N′-(ethane-1,2-diylidene)bis{2,4-dimethyl-6-(2,6-diethylphenyl)aniline-κN}]palladium, chloro(methyl)[N,N′-(ethane-1,2-diylidene)bis{2,4-dimethyl-6-(2,6-di-n-propylphenyl)aniline-κN}]palladium, chloro(methyl)[N,N′-(ethane-1,2-diylidene)bis{2,4-dimethyl-6-(2,6-diisopropylphenyl)aniline-κN}]palladium, chloro(methyl)[N,N′-(ethane-1,2-diylidene)bis{2,4-dimethyl-6-(2-methyl-6-ethylphenyl)aniline-κN}]palladium, chloro(methyl)[N,N′-(ethane-1,2-diylidene)bis{2,4-dimethyl-6-(2-methyl-6-n-propylphenyl)aniline-κN}]palladium, chloro(methyl)[N,N′-(ethane-1,2-diylidene)bis{2,4-dimethyl-6-(2-methyl-6-isopropylphenyl)aniline-κN}]palladium, chloro(methyl)[N,N′-(ethane-1,2-diylidene)bis(2,4-dimethyl-6-(2-ethyl-6-n-propylphenyl)aniline-κN)]palladium, chloro(methyl)[N,N′-(ethane-1,2-diylidene)bis{2,4-dimethyl-6-(2-ethyl-6-isopropylphenyl)aniline-κN}]palladium, chloro(methyl)[N,N′-(ethane-1,2-diylidene)bis{2,4-dimethyl-6-(1-naphthyl)aniline-κN}]palladium, chloro(methyl)[N,N′-(butane-2,3-diylidene)bis(aniline-κN)]palladium, chloro(methyl)[N,N′-(butane-2,3-diylidene)bis(2-methylaniline-κN)]palladium, chloro(methyl)[N,N′-(butane-2,3-diylidene)bis(2-ethylaniline-κN)]palladium, chloro(methyl)[N,N′-(butane-2,3-diylidene)bis (2-n-propylaniline-κN)]palladium, chloro(methyl)[N,N′-(butane-2,3-diylidene)bis (2-isopropylaniline-κN)]palladium, chloro(methyl)[N,N′-(butane-2,3-diylidene)bis (2-n-butylaniline-κN)]palladium, chloro(methyl)[N,N′-(butane-2,3-diylidene)bis (2-isobutylaniline-κN)]palladium, chloro(methyl)[N,N′-(butane-2,3-diylidene)bis (2-n-hexylaniline-κN)]palladium, chloro(methyl)[N,N′-(butane-2,3-diylidene)bis (4-methylaniline-κN)]palladium, chloro(methyl)[N,N′-(butane-2,3-diylidene)bis (2,6-dimethylaniline-κN)]palladium, chloro(methyl)[N,N′-(butane-2,3-diylidene)bis (2,6-diethylaniline-κN)]palladium, chloro(methyl)[N,N′-(butane-2,3-diylidene)bis (2,6-di-n-propylaniline-κN)]palladium, chloro(methyl)[N,N′-(butane-2,3-diylidene)bis (2,6-diisopropylaniline-κN)]palladium, chloro(methyl)[N,N′-(butane-2,3-diylidene)bis (2,6-di-n-butylaniline-κN)]palladium, chloro(methyl)[N,N′-(butane-2,3-diylidene)bis (2,6-disobutylaniline-κN)]palladium, chloro(methyl)[N,N′-(butane-2,3-diylidene)bis (2,6-di-n-hexylaniline-κN)]palladium, chloro(methyl)[N,N′-(butane-2,3-diylidene)bis (2-methyl-6-ethylaniline-κN)]palladium, chloro(methyl)[N,N′-(butane-2,3-diylidene)bis (2-methyl-6-n-propylaniline-κN)]palladium, chloro(methyl)[N,N′-(butane-2,3-diylidene)bis(2-methyl-6-isopropylaniline-κN)]palladium, chloro(methyl)[N,N′-(butane-2,3-diylidene)bis(2-methyl-6-butylaniline-κN)]palladium, chloro(methyl)[N,N′-(butane-2,3-diylidene)bis(2-ethyl-6-n-propylaniline-κN)]palladium, chloro(methyl)[N,N′-(butane-2,3-diylidene)bis(2-ethyl-6-isopropylaniline-κN)]palladium, chloro(methyl)[N,N′-(butane-2,3-diylidene)bis(2-ethyl-6-n-butylaniline-κN)]palladium, chloro(methyl)[N,N′-(butane-2,3-diylidene)bis(2-n-propyl-6-isopropylaniline-κN)]palladium, chloro(methyl)[N,N′-(butane-2,3-diylidene)bis(2-n-propyl-6-n-butylaniline-κN)]palladium, chloro(methyl)[N,N′-(butane-2,3-diylidene)bis(2-isopropyl-6-n-butylaniline-κN)]palladium, chloro(methyl)[N,N′-(butane-2,3-diylidene)bis(2,4,6-trimethylaniline-κN)]palladium, chloro(methyl)[N,N′-(butane-2,3-diylidene)bis{2,4-dimethyl-6-(2-methylphenyl)aniline-κN}]palladium, chloro(methyl)[N,N′-(butane-2,3-diylidene)bis(2,4-dimethyl-6-(2-ethylphenyl)aniline-κN)]palladium, chloro(methyl)[N,N′-(butane-2,3-diylidene)bis{2,4-dimethyl-6-(2-n-propylphenyl)aniline-κN}]palladium, chloro(methyl)[N,N′-(butane-2,3-diylidene)bis{2,4-dimethyl-6-(2-isopropylphenyl)aniline-κN}]palladium, chloro(methyl)[N,N′-(butane-2,3-diylidene)bis{2,4-dimethyl-6-(2,6-dimethylphenyl)aniline-κN}]palladium, chloro(methyl)[N,N′-(butane-2,3-diylidene)bis{2,4-dimethyl-6-(2,6-diethylphenyl)aniline-κN}]palladium, chloro(methyl)[N,N′-(butane-2,3-diylidene)bis{2,4-dimethyl-6-(2,6-di-n-propylphenyl)aniline-κN}]palladium, chloro(methyl)[N,N′-(butane-2,3-diylidene)bis{2,4-dimethyl-6-(2,6-diisopropylphenyl)aniline-κN}]palladium, chloro(methyl)[N,N′-(butane-2,3-diylidene)bis{2,4-dimethyl-6-(2-methyl-6-ethylphenyl)aniline-κN}]palladium, chloro(methyl)[N,N′-(butane-2,3-diylidene)bis{2,4-dimethyl-6-(2-methyl-6-n-propylphenyl)aniline-κN}]palladium, chloro(methyl)[N,N′-(butane-2,3-diylidene)bis{2,4-dimethyl-6-(2-methyl-6-isopropylphenyl)aniline-κN}]palladium, chloro(methyl)[N,N′-(butane-2,3-diylidene)bis{2,4-dimethyl-6-(2-ethyl-6-n-propylphenyl)aniline-κN}]palladium, chloro(methyl)[N,N′-(butane-2,3-diylidene)bis{2,4-dimethyl-6-(2-ethyl-6-isopropylphenyl)aniline-κN}]palladium, chloro(methyl)[N,N′-(butane-2,3-diylidene)bis{2,4-dimethyl-6-(1-naphthyl)aniline-κN}]palladium, chloro(methyl)[N,N′-(1,2-dihydroacenaphthylene-1,2-diylidene)bis(aniline-κN)]palladium, chloro(methyl)[N,N′-(1,2-dihydroacenaphthylene-1,2-diylidene)bis(2-methylaniline-κN)]palladium, chloro(methyl)[N,N′-(1,2-dihydroacenaphthylene-1,2-diylidene)bis(2-ethylaniline-κN)]palladium, chloro(methyl)[N,N′-(1,2-dihydroacenaphthylene-1,2-diylidene)bis(2-n-propylaniline-κN)]palladium, chloro(methyl)[N,N′-(1,2-dihydroacenaphthylene-1,2-diylidene)bis(2-isopropylaniline-κN)]palladium, chloro(methyl)[N,N′-(1,2-dihydroacenaphthylene-1,2-diylidene)bis(2-n-butylaniline-κN)]palladium, chloro(methyl)[N,N′-(1,2-dihydroacenaphthylene-1,2-diylidene)bis(2-isobutylaniline-κN)]palladium, chloro(methyl)[N,N′-(1,2-dihydroacenaphthylene-1,2-diylidene)bis(2-n-hexylaniline-κN)]palladium, chloro(methyl)[N,N′-(1,2-dihydroacenaphthylene-1,2-diylidene)bis(4-methylaniline-κN)]palladium, chloro(methyl)[N,N′-(1,2-dihydroacenaphthylene-1,2-diylidene)bis(2,6-dimethylaniline-κN)]palladium, chloro(methyl)[N,N′-(1,2-dihydroacenaphthylene-1,2-diylidene)bis(2,6-diethylaniline-κN)]palladium, chloro(methyl)[N,N′-(1,2-dihydroacenaphthylene-1,2-diylidene)bis(2,6-di-n-propylaniline-κN)]palladium, chloro(methyl)[N,N′-(1,2-dihydroacenaphthylene-1,2-diylidene)bis(2,6-diisopropylaniline-κN)]palladium, chloro(methyl)[N,N′-(1,2-dihydroacenaphthylene-1,2-diylidene)bis(2,6-di-n-butylaniline-κN)]palladium, chloro(methyl)[N,N′-(1,2-dihydroacenaphthylene-1,2-diylidene)bis(2,6-diisobutylaniline-κN)]palladium, chloro(methyl)[N,N′-(1,2-dihydroacenaphthylene-1,2-diylidene)bis(2,6-di-n-hexylaniline-κN)]palladium, chloro(methyl)[N,N′-(1,2-dihydroacenaphthylene-1,2-diylidene)bis(2,6-dichloroaniline-κN)]palladium, chloro(methyl)[N,N′-(1,2-dihydroacenaphthylene-1,2-diylidene)bis(2-methyl-6-ethylaniline-κN)]palladium, chloro(methyl)[N,N′-(1,2-dihydroacenaphthylene-1,2-diylidene)bis(2-methyl-6-n-propylaniline-κN)]palladium, chloro(methyl)[N,N′-(1,2-dihydroacenaphthylene-1,2-diylidene)bis(2-methyl-6-isopropylaniline-κN)]palladium, chloro(methyl)[N,N′-(1,2-dihydroacenaphthylene-1,2-diylidene)bis(2-methyl-6-butylaniline-κN)]palladium, chloro(methyl)[N,N′-(1,2-dihydroacenaphthylene-1,2-diylidene)bis(2-ethyl-6-n-propylaniline-κN)]palladium, chloro(methyl)[N,N′-(1,2-dihydroacenaphthylene-1,2-diylidene)bis(2-ethyl-6-isopropylaniline-κN)]palladium, chloro(methyl)[N,N′-(1,2-dihydroacenaphthylene-1,2-diylidene)bis(2-ethyl-6-n-butylaniline-κN)]palladium, chloro(methyl)[N,N′-(1,2-dihydroacenaphthylene-1,2-diylidene)bis(2-n-propyl-6-isopropylaniline-κN)]palladium, chloro(methyl)[N,N′-(1,2-dihydroacenaphthylene-1,2-diylidene)bis(2-n-propyl-6-n-butylaniline-κN)]palladium, chloro(methyl)[N,N′-(1,2-dihydroacenaphthylene-1,2-diylidene)bis(2-isopropyl-6-n-butylaniline-κN)]palladium, chloro(methyl)[N,N′-(1,2-dihydroacenaphthylene-1,2-diylidene)bis(2,4,6-trimethylaniline-κN)]palladium, chloro(methyl)[N,N′-(1,2-dihydroacenaphthylene-1,2-diylidene)bis{2,4-dimethyl-6-(2-methylphenyl)aniline-κN}]palladium, chloro(methyl)[N,N′-(1,2-dihydroacenaphthylene-1,2-diylidene)bis{2,4-dimethyl-6-(2-ethylphenyl)aniline-κN}]palladium, chloro(methyl)[N,N′-(1,2-dihydroacenaphthylene-1,2-diylidene)bis{2,4-dimethyl-6-(2-n-propylphenyl)aniline-κN}]palladium, chloro(methyl)[N,N′-(1,2-dihydroacenaphthylene-1,2-diylidene)bis{2,4-dimethyl-6-(2-isopropylphenyl)aniline-κN}]palladium, chloro(methyl)[N,N′-(1,2-dihydroacenaphthylene-1,2-diylidene)bis{2,4-dimethyl-6-(2,6-dimethylphenyl)aniline-κN}]palladium, chloro(methyl)[N,N′-(1,2-dihydroacenaphthylene-1,2-diylidene)bis{2,4-dimethyl-6-(2,6-diethylphenyl)aniline-κN}]palladium, chloro(methyl)[N,N′-(1,2-dihydroacenaphthylene-1,2-diylidene)bis{2,4-dimethyl-6-(2,6-di-n-propylphenyl)aniline-κN}]palladium, chloro(methyl)[N,N′-(1,2-dihydroacenaphthylene-1,2-diylidene)bis{2,4-dimethyl-6-(2,6-diisopropylphenyl)aniline-κN}]palladium, chloro(methyl)[N,N′-(1,2-dihydroacenaphthylene-1,2-diylidene)bis{2,4-dimethyl-6-(2-methyl-6-ethylphenyl) aniline-κN}]palladium, chloro(methyl)[N,N′-(1,2-dihydroacenaphthylene-1,2-diylidene)bis{2,4-dimethyl-6-(2-methyl-6-n-propylphenyl) aniline-κN}]palladium, chloro(methyl)[N,N′-(1,2-dihydroacenaphthylene-1,2-diylidene)bis{2,4-dimethyl-6-(2-methyl-6-isopropylphenyl) aniline-κN}]palladium, chloro(methyl)[N,N′-(1,2-dihydroacenaphthylene-1,2-diylidene)bis{2,4-dimethyl-6-(2-ethyl-6-n-propylphenyl) aniline-κN}]palladium, chloro(methyl)[N,N′-(1,2-dihydroacenaphthylene-1,2-diylidene)bis{2,4-dimethyl-6-(2-ethyl-6-isopropylphenyl) aniline-κN}]palladium, and chloro(methyl)[N,N′-(1,2-dihydroacenaphthylene-1,2-diylidene)bis{2,4-dimethyl-6-(1-naphthyl)aniline-κN}]palladium.

Examples of the transition metal compound represented by formula (4), wherein M¹ is a nickel atom, a cobalt atom, a rhodium atom or a ruthenium atom, are compounds obtained by replacing the term “palladium” of the above-exemplified palladium compounds with the term “nickel”, “cobalt”, “rhodium” or “ruthenium”.

Examples of the transition metal compound represented by formula (4), wherein M is an iron atom, are 2,6-bis-[1-(2,6-dimethylphenylimino)ethyl]pyridineiron dichloride, 2,6-bis-[1-(2,6-diisopropylphenylimino)ethyl]pyridineiron dichloride, 2,6-bis-[1-(2,6-dichlorophenylimino) ethyl]pyridineiron dichloride, 2,6-bis-[1-(2-methyl-6-isopropylphenylimino)ethyl]pyridineiron dichloride, 2,6-bis-[1-(2-tert-butylphenylimino)ethyl]pyridineiron dichloride, [hydrotris(3,5-dimethylpyrazolyl)borate]iron chloride, [hydrotris(3,5-dimethylpyrazolyl)borate]iron bromide, [hydrotris(3,5-dimethylpyrazolyl)borate]iron iodide, [hydrotris(3,5-dimethylpyrazolyl)borate]iron methyl, [hydrotris(3,5-dimethylpyrazolyl)borate]iron ethyl, [hydrotris(3,5-dimethylpyrazolyl)borate]iron allyl, [hydrotris(3,5-dimethylpyrazolyl)borate]iron methallyl, [hydrotris(3,5-diethylpyrazolyl)borate]iron chloride, [hydrotris(3,5-diethylpyrazolyl)borate]iron bromide, [hydrotris(3,5-diethylpyrazolyl)borate]iron iodide, [hydrotris(3,5-diethylpyrazolyl)borate]iron methyl, [hydrotris(3,5-diethylpyrazolyl)borate]iron ethyl, [hydrotris(3,5-diethylpyrazolyl)borate]iron allyl, [hydrotris(3,5-diethylpyrazolyl)borate]iron methallyl, [hydrotris(3,5-di-tert-butylpyrazolyl)borate]iron chloride, [hydrotris(3,5-di-tert-butylpyrazolyl)borate]iron bromide, [hydrotris(3,5-di-tert-butylpyrazolyl)borate]iron iodide, [hydrotris(3,5-di-tert-butylpyrazolyl)borate]iron methyl, [hydrotris(3,5-di-tert-butylpyrazolyl)borate]iron ethyl, [hydrotris(3,5-di-tert-butylpyrazolyl)borate]iron allyl, and [hydrotris(3,5-di-tert-butylpyrazolyl)borate]iron methallyl.

Examples of the transition metal compound represented by the formula (4), wherein M¹ is a cobalt atom or a nickel atom, are compounds obtained by replacing the term “iron” of the above-exemplified iron compounds with the term “cobalt” or “nickel”.

The above-mentioned transition metal compounds may be used in combination of two or more thereof.

The transition metal compound is preferably a compound represented by the following formula [I]:

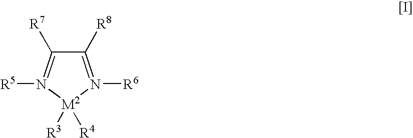

wherein M² is a transition metal atom of Group 10 of the Periodic Table of the elements; R³ and R⁴ are independently of each other a hydrogen atom, a halogen atom, an alkyl group, an aralkyl group, an aryl group, a silyl group, a siloxy group, an alkoxy group, an aralkyloxy group or an aryloxy group; R⁵ and R⁶ are independently of each other a hydrocarbyl group having 1 to 30 carbon atoms; and R⁷ and R⁸ are independently of each other a hydrogen atom or a hydrocarbyl group having 1 to 20 carbon atoms, and R⁷ and R⁸ may be linked with each other to form a ring.

M² is preferably a nickel atom or a palladium atom, and further preferably a palladium atom.

Examples of the halogen atom of R³ and R⁴ are a fluorine atom, a chlorine atom, a bromine atom, and an iodine atom. Among them, preferred is a chlorine atom or a bromine atom.

Examples of the alkyl group of R³ and R⁴ are linear alkyl groups such as a methyl group, an ethyl group, and a n-butyl group; branched alkyl groups such as an isopropyl group, an isobutyl group, a tert-butyl group, and a neopentyl group; and cyclic alkyl groups such as a cyclohexyl group and a cyclooctyl group. Among them, preferred is a linear alkyl group, more preferred is a linear alkyl group having 1 to 12 carbon atoms, and further preferred is a methyl group.

Examples of the aralkyl group of R³ and R⁴ are a benzyl group and a phenethyl group. Among them, preferred is a benzyl group.

Examples of the aryl group of R³ and R⁴ are a phenyl group, a naphthyl group, a 4-tolyl group, a mesityl group, and a biphenyl group. Among them, preferred is a phenyl group, a 4-tolyl group or a mesityl group.

Examples of the silyl group of R³ and R⁴ are monosubstituted silyl group such as a methylsilyl group, an ethylsilyl group, and a phenylsilyl group; disubstituted silyl groups such as a dimethylsilyl group, a diethylsilyl group, and a diphenylsilyl group; and trisubstituted silyl groups such as a trimethylsilyl group, a trimethoxysilyl group, a dimethylmethoxysilyl group, a methyldimethoxysilyl group, a triethylsilyl group, a triethoxysilyl group, a tri-n-propylsilyl group, a triisopropylsilyl group, a tri-n-butylsilyl group, a tri-sec-butylsilyl group, a tert-butyldimethylsilyl group, a triisobutylsilyl group, a tert-butyldiphenylsilyl group, a cyclohexyldimethylsilyl group, a tricyclohexylsilyl group, and a triphenylsilyl group. Among them, preferred are trisubstituted silyl groups, and more preferred is a trimethylsilyl group, a triethylsilyl group, a triphenylsilyl group, a tert-butyldimethylsilyl group, a tert-butyldiphenylsilyl group, a cyclohexyldimethylsilyl group, or a triisopropylsilyl group.

Examples of the siloxy group of R³ and R⁴ are a trimethylsiloxy group, a trimethoxysiloxy group, a dimethylmethoxysiloxy group, a methyldimethoxysiloxy group, a triethylsiloxy group, a triethoxysiloxy group, a tri-n-propylsiloxy group, a triisopropylsiloxy group, a tri-n-butylsiloxy group, a tri-sec-butylsiloxy group, a tert-butyldimethylsiloxy group, a triisobutylsiloxy group, a tert-butyldiphenylsiloxy group, a cyclohexyldimethylsiloxy group, a tricyclohexylsiloxy group, and a triphenylsiloxy group. Among them, preferred is a trimethylsiloxy group, a triethylsiloxy group, a triphenylsiloxy group, a tert-butyldimethylsiloxy group, a tert-butyldiphenylsiloxy group, a cyclohexyldimethylsiloxy group,

Examples of the alkoxy group of R³ and R⁴ are a methoxy group, an ethoxy group, a n-propoxy group, an isopropoxy group, a n-butoxy group, a sec-butoxy group, a tert-butoxy group, a n-pentyloxy group, a neopentyloxy group, a n-hexyloxy group, a n-octyloxy group, a n-dodecyloxy group, a n-pentadecyloxy group, and a n-eicosyloxy group. Among them, preferred is an alkoxy group having 1 to 20 carbon atoms, and more preferred is a methoxy group, an ethoxy group, an isopropoxy group, or a tert-butoxy group.

Examples of the aralkyloxy group of R³ and R⁴ are a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, a (n-propylphenyl)methoxy group, an (isopropylphenyl)methoxy group, a (n-butylphenyl)methoxy group, a (sec-butylphenyl)methoxy group, a (tert-butylphenyl)methoxy group, a (n-hexylphenyl)methoxy group, a (n-octylphenyl)methoxy group, a (n-decylphenyl)methoxy group, a naphthylmethoxy group, and an anthrathenylmethoxy group. Among them, preferred is a benzyloxy group.

Examples of the aryloxy group of R³ and R⁴ are a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2-tert-butyl-3-methylphenoxy group, a 2-tert-butyl-4-methylphenoxy group, a 2-tert-butyl-5-methylphenoxy group, a 2-tert-butyl-6-methylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 2-tert-butyl-3,4-dimethylphenoxy group, a 2-tert-butyl-3,5-dimethylphenoxy group, a 2-tert-butyl-3,6-dimethylphenoxy group, a 2,6-di-tert-butyl-3-methylphenoxy group, a 2-tert-butyl-4,5-dimethylphenoxy group, a 2,6-di-tert-butyl-4-methylphenoxy group, a 3,4,5-trimethylphenoxy group, a 2,3,4,5-tetramethylphenoxy group, a 2-tert-butyl-3,4,5-trimethylphenoxy group, a 2,3,4,6-tetramethylphenoxy group, a 2-tert-butyl-3,4,6-trimethylphenoxy group, a 2,6-di-tert-butyl-3,4-dimethylphenoxy group, a 2,3,5,6-tetramethylphenoxy group, a 2-tert-butyl-3,5,6-trimethylphenoxy group, a 2,6-di-tert-butyl-3,5-dimethylphenoxy group, a pentamethylphenoxy group, an ethylphenoxy group, a n-propylphenoxy group, an isopropylphenoxy group, a n-butylphenoxy group, a sec-butylphenoxy group, a tert-butylphenoxy group, a n-hexylphenoxy group, a n-octylphenoxy group, a n-decylphenoxy group, anaphthoxy group, and an anthrathenoxy group. Among them, preferred is an aryloxy group having 6 to 20 carbon atoms.

R³ and R⁴ are preferably a hydrogen atom, a halogen atom, an alkyl group or an aryl group; more preferably a hydrogen atom, a halogen atom or a non-substituted linear alkyl group having 1 to 12 carbon atoms; and particularly preferred is a chlorine atom or a methyl group.

Examples of the hydrocarbyl group having 1 to 30 carbon atoms of R⁵ and R⁶ are an alkyl group, an aralkyl group and an aryl group. Those groups may have a substituent such as a halogen atom, a hydrocarbyloxy group, a nitro group, a sulfonyl group, and a silyl group.

Examples of the alkyl group of R⁵ and R⁶ are linear alkyl groups such as a methyl group, an ethyl group, and a n-butyl group; branched alkyl groups such as an isopropyl group, an isobutyl group, a tert-butyl group, and a neopentyl group; and cyclic alkyl groups such as a cyclohexyl group and a cyclooctyl group. Among them, preferred is a branched alkyl group, more preferred is a branched alkyl group having 1 to 12 carbon atoms, and further preferred is an isopropyl group or a tert-butyl group.

Examples of the aralkyl group of R⁵ and R⁶ are a benzyl group and a phenethyl group. Among them, preferred is a benzyl group.

Examples of the aryl group of R⁵ and R⁶ are a phenyl group, a 2-methylphenyl group, a 2-ethylphenyl group, a 2-n-propylphenyl group, a 2-isopropylphenyl group, a 2-n-butylphenyl group, a 2-isobutylphenyl group, a 2-n-hexylphenyl group, a 4-methylphenyl group, a 2,6-dimethylphenyl group, a 2,6-diethylphenyl group, a 2,6-di-n-propylphenyl group, a 2,6-diisopropylphenyl group, a 2,6-di-n-butylphenyl group, a 2,6-diisobutylphenyl group, a 2,6-di-n-hexylphenyl group, a 2-methyl-6-ethylphenyl group, a 2-methyl-6-n-propylphenyl group, a 2-methyl-6-isopropylphenyl group, a 2-methyl-6-butylphenyl group, a 2-ethyl-6-n-propylphenyl group, a 2-ethyl-6-isopropylphenyl group, a 2-ethyl-6-n-butylphenyl group, a 2-n-propyl-6-isopropylphenyl group, a 2-n-propyl-6-n-butylphenyl group, a 2-isopropyl-6-n-butylphenyl group, a 2,4,6-trimethylphenyl group, a 2,4-dimethyl-6-(2-methylphenyl)phenyl group, a 2,4-dimethyl-6-(2-ethylphenyl)phenyl group, a 2,4-dimethyl-6-(2-n-propylphenyl)phenyl group, a 2,4-dimethyl-6-(2-isopropylphenyl)phenyl group, a 2,4-dimethyl-6-(2,6-dimethylphenyl)phenyl group, a 2,4-dimethyl-6-(2,6-diethylphenyl)phenyl group, a 2,4-dimethyl-6-(2,6-di-n-propylphenyl)phenyl group, a 2,4-dimethyl-6-(2,6-diisopropylphenyl)phenyl group, a 2,4-dimethyl-6-(2-methyl-6-ethylphenyl)phenyl group, a 2,4-dimethyl-6-(2-methyl-6-n-propylphenyl)phenyl group, a 2,4-dimethyl-6-(2-methyl-6-isopropylphenyl)phenyl group, a 2,4-dimethyl-6-(2-ethyl-6-n-propylphenyl)phenyl group, a 2,4-dimethyl-6-(2-ethyl-6-isopropylphenyl)phenyl group, and a 2,4-dimethyl-6-(1-naphthyl)phenyl group. Among them, preferred is an aryl group having 6 to 30 carbon atoms, and more preferred is an aryl group having 7 to 30 carbon atoms.

Examples of the hydrocarbyl group having 1 to 20 carbon atoms of R⁷ and R⁸ are an alkyl group and an aryl group. Those groups may have a substituent such as a halogen atom, a hydrocarbyloxy group, a nitro group, a sulfonyl group, and a silyl group.

Examples of the alkyl group of R⁷ and R⁸ are linear alkyl groups such as a methyl group, an ethyl group, and a n-butyl group; branched alkyl groups such as an isopropyl group, an isobutyl group, a tert-butyl group, and a neopentyl group; and cyclic alkyl groups such as a cyclohexyl group and a cyclooctyl group. Among them, preferred is a linear alkyl group, more preferred is a linear alkyl group having 1 to 12 carbon atoms, and further preferred is a methyl group or an ethyl group.

Examples of the aryl group of R⁷ and R⁸ are a phenyl group, a naphthyl group, a 4-tolyl group, and a mesityl group. Among them, preferred is an aryl group having 6 to 20 carbon atoms, more preferred is an aryl group having 6 to 12 carbon atoms, and further preferred is a phenyl group or a mesityl group.

When R⁷ and R⁸ are linked with each other to form a ring, examples of the ring are an aliphatic ring and an aromatic ring. Those rings may have a substituent. Examples of a divalent group forming the aliphatic ring are a 1,2-ethylene group, a 1,2-cyclohexylene group, a 1,2-norbornene group, a 2,3-butene group, a 2,3-dimethyl-2,3-butene group, and a 2,4-pentene group. Examples of a divalent group forming the aromatic ring are a 1,2-phenylene group and a naphthalen-1,8-diyl group. Among them, preferred is a naphthalen-1,8-diyl group. One bond contained in each of these divalent groups is linked with the R⁷-carrying carbon atom in formula [I], and the other bond contained therein is linked with the R⁸-carrying carbon atom therein.

An organoaluminum compound in the present invention may be a compound known in the art. Examples of the organoaluminum compound are the following compounds (1) to (3), and a combination of two or more thereof:

(1) an organoaluminum compound represented by the formula, E¹_{d}AlX²_{3-d};

(2) a cyclic alumoxane represented by the formula, {—Al(E²)-O—}ₑ; and

(3) a linear alumoxane represented by the formula, E³{-Al(E³)-O—}_{f}AlE³₂,

wherein E¹, E² and E³ are independently of one another a hydrocarbyl group, and when plural E¹s, E²s or E³s exist, they are the same as, or different from one another; X² is a hydrogen atom or a halogen atom, and when plural Xs exist, they are the same as, or different from one another; d is a number satisfying 0<d≦3; e is an integer of 2 or more, and preferably an integer of 2 to 40; and f is an integer of 1 or more, and preferably an integer of 1 to 40.

The hydrocarbyl group of E¹, E² and E³ is preferably a hydrocarbyl group having 1 to 8 carbon atoms, and more preferably an alkyl group having 1 to 8 carbon atoms. Examples of the alkyl group of E¹, E² and E³ are a methyl group, an ethyl group, a n-propyl group, an isopropyl group, a n-butyl group, an isobutyl group, a n-pentyl group, and a neopentyl group. Among them, preferred is a methyl group or an isobutyl group.

Examples of the above-mentioned organoaluminum compound (1) are trialkylaluminums such as trimethylaluminum, triethylaluminum, tripropylaluminum, triisobutylaluminum, and trihexylaluminum; dialkylaluminum chlorides such as dimethylaluminum chloride, diethylaluminum chloride, dipropylaluminum chloride, diisobutylaluminum chloride and dihexylaluminum chloride; alkylaluminum dichlorides such as methylaluminum dichloride, ethylaluminum dichloride, propylaluminum dichloride, isobutylaluminum dichloride and hexylaluminum dichloride; and dialkylaluminum hydrides such as dimethylaluminum hydride, diethylaluminum hydride, dipropylaluminum hydride, diisobutylaluminum hydride and dihexylaluminum hydride. Among them, preferred is a trialkylaluminum, and more preferred is triethylaluminum or triisobutylaluminum.

The above-mentioned cyclic alumoxane (2) and linear alumoxane (3) can be produced according to various processes. Those processes are not particularly limited, and may be those known in the art. Examples of the process are (i) a process comprising the step of contacting a solution of a trialkylaluminum such as trimethylaluminum in a suitable organic solvent such as benzene and an aliphatic hydrocarbon with water, and (ii) a process comprising the step of contacting a trialkylaluminum such as trimethylaluminum with a crystal water-containing metal salt such as copper sulfate hydrate.

A boron compound in the present invention may be a compound known in the art. Examples of the boron compound are the following compounds (1) to (3), and a combination of two or more thereof:

(1) a boron compound represented by the formula, BQ¹Q²Q³;

(2) a boron compound represented by the formula, G⁺(BQ¹Q²Q³Q⁴)⁻; and

(3) a boron compound represented by the formula, (J-H)⁺(BQ¹Q²Q³Q⁴)⁻;

wherein B is a trivalent boron atom; Q¹, Q², Q³ and Q⁴ are independently of one another a halogen atom, a hydrocarbyl group, a halogenated hydrocarbyl group, a silyl group, a siloxy group, an alkoxy group, an amino group, an amido group, or an imido group; G⁺ is an inorganic or organic cation; J is a neutral Lewis base; and (J-H)⁺ is a Broensted acid.

Q¹, Q², Q³ and Q⁴ in the above-mentioned formulas are preferably a halogen atom, a hydrocarbyl group having 1 to 20 carbon atoms, a halogenated hydrocarbyl group having 1 to 20 carbon atoms, a silyl group having 1 to 20 carbon atoms, a siloxy group having 1 to 20 carbon atoms, a C₂₋₂₀ hydrocarbyl group-carrying amino group, a C₂₋₂₀ hydrocarbyl group-carrying amido group, or a C₂₋₂₀ hydrocarbyl group-carrying imido group; more preferably a halogen atom, a hydrocarbyl group having 1 to 20 carbon atoms, or a halogenated hydrocarbyl group having 1 to 20 carbon atoms; further preferably a C₁₋₂₀ fluorinated hydrocarbyl group containing one or more fluorine atoms; and particularly preferably a C₆₋₂₀ fluorinated aryl group containing one or more fluorine atoms.

Examples of the above-mentioned boron compound (1) are tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, and phenylbis(pentafluorophenyl)borane. Among them, most preferred is tris(pentafluorophenyl)borane.

Examples of an inorganic cation, G⁺, in the above-mentioned boron compound (2) are a ferrocenium cation, an alkyl group-having ferrocenium cation, and a silver cation. An example of an organic cation, G⁺, therein is a barbenium cation such as a triphenylmethyl cation. Among them, G⁺ is preferably a carbenium cation, and particularly preferably a triphenylmethyl cation.

Examples of (BQ¹Q²Q³Q⁴)⁻ in the above-mentioned boron compound (2) are tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,3,4-trifluorophenyl)borate, phenyltris(pentafluorophenyl)borate, and tetrakis(3,5-bistrifluoromethylphenyl)borate.

Examples of the above-mentioned boron compound (2) are lithium tetrakis(3,5-bistrifluoromethylphenyl)borate, sodium tetrakis(3,5-bistrifluoromethylphenyl)borate, potassium tetrakis(3,5-bistrifluoromethylphenyl)borate, silver tetrakis(pentafluorophenyl)borate, ferrocenium tetrakis(pentafluorophenyl)borate, 1,1′-dimethylferrocenium tetrakis(pentafluorophenyl)borate, tetrabutylphosphponium tetrakis(pentafluorophenyl)borate, tetraphenylphosphponium tetrakis(pentafluorophenyl)borate, tetramethylammonium tetrakis(pentafluorophenyl)borate, trimethylsulphonuim tetrakis(pentafluorophenyl)borate, diphenyliodonium tetrakis(pentafluorophenyl)borate, triphenylcarbenium tetrakis(pentafluorophenyl)borate, and triphenylcarbenium tetrakis(3,5-bistrifluoromethylphenyl)borate. Among them, most preferred is triphenylcarbenium tetrakis(pentafluorophenyl)borate.

Examples of (J-H)⁺ in the above-mentioned boron compound (3) are a trialkylammonium, an N,N-dialkylanilinium, a dialkylammonium, and a triarylphosphonium. Examples of the (BQ¹Q²Q³Q⁴)⁻ therein are the same as those mentioned above.

Examples of the above-mentioned boron compound (3) are triethylammonium tetrakis(pentafluorophenyl)borate, tripropylammonium tetrakis(pentafluorophenyl)borate, tri(n-butyl)ammonium tetrakis(pentafluorophenyl)borate, tri(n-butyl)ammonium tetrakis(3,5-bistrifluoromethylphenyl) borate, N,N-dimethylanilinium tetrakis(pentafluorophenyl) borate, N,N-diethylanilinium tetrakis(pentafluorophenyl) borate, N,N-dimethyl-2,4,6-trimethylanilinium tetrakis (pentafluorophenyl)borate, N,N-dimethylanilinium tetrakis (3,5-bistrifluoromethylphenyl)borate, diisopropylammonium tetrakis(pentafluorophenyl)borate, dicyclohexylammonium tetrakis(pentafluorophenyl)borate, triphenylphosphonium tetrakis(pentafluorophenyl)borate, tri(methylphenyl) phosphonium tetrakis(pentafluorophenyl)borate, and tri(dimethylphenyl)phosphonium tetrakis(pentafluorophenyl) borate. Among them, most preferred is tri(n-butyl)ammonium tetrakis(pentafluorophenyl)borate, or N,N-dimethylanilinium tetrakis(pentafluorophenyl)borate.

The boron compound is preferably the above-mentioned boron compound (2) or (3), and particularly preferably triphenylcarbenium tetrakis(pentafluorophenyl)borate, tri(n-butyl)ammonium tetrakis(pentafluorophenyl)borate, or N,N-dimethylanilinium tetrakis(pentafluorophenyl)borate.

An amount of units represented by the formula (1) contained in the copolymer of the present invention, for example, an amount of isopropylidene diallylmalonate units represented by the formula (1) contained in a copolymer of isopropylidene diallylmalonate compound represented by the formula (3) with cyclopentene is measured according to a ¹H-NMR method comprising the steps of:

(1) preparing a chloroform-d₁ solution of a copolymer, the solution having a concentration of preferably 4 mg/mL to 2 g/mL;

(2) measuring a ¹H-NMR spectrum of the solution, thereby obtaining a spectrum;

(3) obtaining a peak area (A₁) in the spectrum existing in a range of 0.5 to 2.1 ppm, which contains a methine group and a methylene group (8H) in a cyclopentane-1,3-diyl structure derived from cyclopentene;

(4) obtaining a peak area (A₂) in the spectrum existing in a range of 2.3 to 2.6 ppm based on one methylene groups (2H) of a cyclopentane-1,2-diyl structure contained in the unit represented by the formula (1) (A⁵=A⁶=A⁷=A⁸=H); and

(5) calculating an amount of the unit represented by the formula (1) from the following formula,

amount (% by mol) of units represented by the formula (1)=100×(A₂)/2÷[(A₂)/2+{(A₁)−(A₂)/2×14}/8]

wherein the total amount of units represented by the formula (1) and cyclopentene units is 100% by mol.

In a ¹³C-NMR spectrum of the above-mentioned copolymer, a peak appearing at 47.0 ppm is assigned to a carbon atom derived from a methylene group of a cyclopentane ring, which is separated by four or more methylene groups in a bone structure of a copolymer, and a peak appearing at 46.5 ppm is assigned to a carbon atom derived from a methylene group of a cyclopentane ring, which is separated by two methylene groups in a bone structure of a copolymer, provided that a peak assigned to chloroform-d₁ appears at 77 ppm.

An amount of units represented by the formula (1) contained in the copolymer of the present invention is not particularly limited, and is generally larger than 0% by mol, and smaller than 100% by mol, the total of those units and cyclic olefin units being 100% by mol. In order to produce a copolymer having a superior heat resistance, the amount thereof is preferably 10% by mol or larger, and smaller than 100% by mol, and more preferably 20% by mol or larger, and smaller than 100% by mol.

A molecular weight of the copolymer of the present invention is not particularly limited. Its weight-average molecular weight (Mw) is preferably 1,000 to 10,000,000, more preferably 2,000 to 5,000,000, and most preferably 4,000 to 3,000,000.

A molecular weight distribution of the copolymer of the present invention is not particularly limited. It is preferably 1.0 to 100, more preferably 1.0 to 50, and most preferably 1.0 to 20.

A glass-transition temperature (indicator of heat resistance) of the copolymer in the present invention is preferably 60° C. or higher, more preferably 70° C. or higher, and most preferably 80° C. or higher.

The copolymer of the present invention is soluble in aromatic solvents such as toluene and xylene, or in hydrogenated solvents such as chloroform and methylene chloride.

In the present invention, a method for contacting (i) the above-mentioned transition metal compound, (ii) the above-mentioned organoaluminum compound and/or boron compound, and (iii) the above-mentioned monomers (at least the compound represented by the formula (3) and cyclic olefins), with one another, is not particularly limited.

When forming a polymerization catalyst by contacting the transition metal compound with the organoaluminum compound, the organoaluminum compound is preferably the above-mentioned cyclic alumoxane, linear alumoxane, or a combination thereof, in order to form a high activity-having polymerization catalyst. When forming a polymerization catalyst by contacting the transition metal compound, the organoaluminum compound and the boron compound with one another, the organoaluminum compound is preferably the organoaluminum compound represented by the above-mentioned first formula, E¹_{d}AlZ_{3-d}, in order to form a high activity-having polymerization catalyst.

The organoaluminum compound is used in amount of generally 0.1 to 10,000 parts by mol, and preferably 5 to 2,000 parts by mol, per one mol of the transition metal compound. The amount of smaller than 0.1 part by mol may result in an insufficient activity of a polymerization catalyst. The amount of larger than 10,000 parts by mol may result in production of a too low molecular weight-having copolymer, because of, for example, chain transfer to the organoaluminum compound, or may result in a too low activity-having polymerization catalyst. The boron compound is used in amount of generally 0.01 to 100 parts by mol, and preferably 0.5 to 10 parts by mol, per one mol of the transition metal compound. The amount of smaller than 0.01 part by mol may result in an insufficient activity of a polymerization catalyst. The amount of larger than 100 parts by mol is not preferable from an economical point of view.

Each of the transition metal compound, the organoaluminum compound, and the boron compound may be used as a solution thereof. Examples of a solvent for the solution are methylene chloride, chloroform, toluene, pentane, hexane, and heptane. Among them, preferred is methylene chloride, chloroform, or toluene.

A solution of the transition metal compound has a concentration of generally 0.01 to 500 μmol/L, preferably 0.05 to 100 μmol/L, and more preferably 0.05 to 50 μmol/L. A solution of the organoaluminum compound has a concentration of generally 0.01 to 10,000 μmol/L, preferably 0.1 to 5,000 μmol/L, and more preferably 0.1 to 2,000 μmol/L, in terms of an amount of an aluminum atom contained in the solution. A solution of the boron compound has a concentration of generally 0.01 to 500 μmol/L, preferably 0.05 to 200 μmol/L, and more preferably 0.05 to 100 μmol/L. When the solution of the transition metal compound has a concentration of lower than 0.01 μmol/L, when the solution of the organoaluminum compound has a concentration of lower than 0.01 μmol/L in terms of an amount of an aluminum atom contained in the solution, or when the solution of the boron compound has a concentration of lower than 0.01 μmol/L, a large amount of a solvent is necessary to prepare the solution, which is not preferable from an economical point of view. When the solution of the transition metal compound has a concentration of higher than 500 μmol/L, when the solution of the organoaluminum compound has a concentration of higher than 10,000 μmol/L in terms of an amount of an aluminum atom contained in the solution, or when the solution of the boron compound has a concentration of higher than 500 μmol/L, the transition metal compound, the organoaluminum compound, or the boron compound may not be sufficiently dissolved in a solvent, and therefore, the compound may be deposited in the solution.

A polymerization catalyst in the present invention may be combined with a carrier or a support comprising particles of inorganic or organic compounds. Examples of the inorganic compounds are silica gel and alumina, and an example of the organic compounds is a styrene unit-containing polymer.

A polymerization method is not particularly limited in the present invention. Examples thereof are a gas-phase polymerization method, a bulk polymerization method, a solution polymerization method using a suitable polymerization solvent, and a suspension polymerization method using the same, which are a batch-wise polymerization method or a continuous polymerization method. The polymerization solvent is a solvent non-deactivating a polymerization catalyst. Examples of the solvent are a hydrocarbon solvent such as benzene, toluene, pentane, hexane, heptane, and cyclohexane; and a halogenated solvent such as dichloromethane and chloroform.

A polymerization temperature is not particularly limited in the present invention, and generally −100 to 250° C., and preferably −50 to 200° C. The polymerization temperature of lower than −100° C. may result in an insufficient activity of a polymerization catalyst. The polymerization temperature of higher than 250° C. may result in production of a too low molecular weight-having copolymer, or may result in production of a copolymer containing no unit represented by the formula (1), due to occurrence of a side reaction such as an isomerization reaction.

In order to regulate a molecular weight of a copolymer produced, a chain transfer agent such as hydrogen may be used.

A polymerization time is not particularly limited in the present invention, and generally one minute to 72 hours. The polymerization time of shorter than one minute may result in an insufficient yield of a copolymer produced. The polymerization time of longer than 72 hours is disadvantageous from an economical point of view.

The copolymer of the present invention may be used in combination with various additives such as weatherability stabilizers, lubricants, pigments, dyes, antistatic agents, antioxidants, antifogging agents, rust-inhibiting agents, surfactants, and electroconductive agents. The copolymer of the present invention may also be used in combination with a polymer known in the art such as a low-density polyethylene, a high-density polyethylene, a linear low-density polyethylene, an ethylene-α-olefin copolymer elastomer, and polypropylene.

The copolymer of the present invention can be molded according to an extrusion molding method or an injection molding method. Those methods may be known in the art. Examples of the extrusion molding method are (1) an inflation molding method comprising the steps of (1-1) extruding a molten resin through a circular die, thereby forming an extruded product, (1-2) blowing the extruded product into a cylindrical film or sheet, and (1-3) rewinding the film or sheet, (2) a T-die molding method comprising the steps of (2-1) extruding a molten resin through a linear die, thereby forming a film or sheet, and (2-2) rewinding the film or sheet, and (3) a calender molding method.

### EXAMPLE

The present invention is explained with reference to the following Example, and the scope of the present invention is not limited thereto.

### Example 1

### (1) Preparation of Compound Represented by Formula (3)

There were placed in a 25 mL-Schlenk tube 0.0065 g of PdCl₂(CH₃CN)₂ and 0.95 mL of methylene chloride and 0.95 mL of methylene chloride, and 0.33 mL of P(OC₆H₅)₃ was added thereto in an atmosphere of a nitrogen gas. The resultant mixture was stirred for 15 minutes at a room temperature, and then, 0.07 mL of triethylamine and 4.54 μL of water were added thereto. The resultant mixture was further stirred for 20 minutes at a room temperature. There were added 5 mL of water thereto, and the resultant mixture was stirred for 5 minutes at a room temperature. Then, the upper water-layer thereof was removed with a cannula. Volatile matters contained in another organic-layer thereof were distilled away, and the resultant residue was washed with acetone, thereby obtaining Pd[P(OC₆H₅)₃]₄. The above-mentioned procedures were carried out according to the method described in The Journal of Organic Chemistry, Vol. 69, page 2595 (2004) authored by Kayaki, Y., Koda, T. and Ikariya, T.

There were placed in a 50 mL-round bottom flask 7.69 g of MOLECULAR SIEVES 3A, 35 mL of toluene, 49.7 mg of the above-produced Pd(OC₆H₅)₃, 5.04 g of 2,2-dimethyl-1,3-dioxane-4,6-dione, and 4.9 ml of allyl alcohol, and the resultant mixture was stirred at 80° C. for 2 hours in an atmosphere of a nitrogen gas. The reaction mixture was filtered, and toluene contained in the filtrate was distilled away. The resultant residue was purified according to a column chromatography having a stationary phase of silica gel and a mobile phase of a mixed solvent consisting of 8 parts by weight of hexane and 1 part by weight of ethyl acetate, thereby obtaining 6.22 g of clear and oily isopropylidene diallylmalonate represented by the formula (3).

### (2) Copolymerization

There were placed in a first 25 mL-Schlenk tube 9.86 mg (0.015 mmol) of chloro(methyl) [N,N′-(1,2-dihydroacenaphthylene-1,2-diylidene)bis(2,6-diisopropylaniline-κN)]palladium (transition metal compound) and 15.95 mg (0.018 mmol) of sodium tetrakis{3,5-bis(trifluoromethyl)phenyl)borate (boron compound), and 0.75 mL of dry methylene chloride manufactured by Kanto Chemical Co., Inc. was added thereto. The resultant mixture was stirred for 5 minutes at a room temperature, thereby preparing a methylene chloride solution of a cationic palladium. There were placed in a second 25 mL-Schlenk tube 0.156 g (0.7 mmol) of isopropylidene diallylmalonate prepared in Example 1(1) and 0.048 g (0.7 mmol) of cyclopentene (cyclic olefin), and then 0.5 mL of the above-prepared methylene chloride solution (0.01 mol of the palladium complex) was added to the second 25 mL-Schlenk tube with a syringe. The resultant mixture was stirred for two hours at a room temperature, thereby copolymerizing them with each other.

The copolymerization reaction mixture was poured into about 100 mL of methanol to precipitate a copolymer. The precipitated copolymer was recovered by filtration, thereby obtaining 0.105 g of a copolymer containing isopropylidene diallylmalonate units represented by the formula (1), and cyclopentene units. The copolymer was solid at a room temperature, and had a number-average molecular weight (Mn) of 8,500; a molecular weight distribution (Mw/Mn) of 1.7; isopropylidene diallylmalonate units represented by the formula (1) in an amount of 25% by mol (therefore, cyclopentene units in an amount of 75% by mol), the total of both units being 100% by mol; and 100% by mol of a trans-form in view of its relative configuration between A⁹ and A¹⁰.

The above-mentioned number-average molecular weight (Mn) and molecular weight distribution (Mw/Mn) were measured under the following conditions according to a gel permeation chromatography (GPC) using an equipment manufactured by JASCO Corporation having a degasser (DG-980-50), a pump (PU-980), an auto-sampler (AS-950), a column oven (CO-966), an RI detector (RI-930) and a UV detector (UV-975), with a calibration curve prepared using standard polystyrenes:
two columns, SHODEX-806L, manufactured by Showa Denko K.K.;
measurement temperature of 40° C.;
solvent of chloroform; and
sample concentration of 1 mg-sample/mL-solution.

The above-mentioned proportion of the trans-form was measured under the following conditions according to a ¹³C-NMR method using an equipment, LA-500, manufactured by JEOL LTD; and the above-mentioned existence of the unit represented by the formula (1) was confirmed by comparing signals of the above-obtained copolymer in the range of 23 to 50 ppm of a ¹³C-NMR spectrum obtained by the ¹³C-NMR method with signals of a homopolymer of isopropylidene diallylmalonate in the same range as mentioned above of a ¹³C-NMR spectrum obtained by the same ¹³C-NMR method as mentioned above:
measurement solvent of chloroform-d₁;
measurement temperature of room temperature;
sample concentration of 50 mg-sample/0.5 mL-solution; and
reference material of chloroform-d₁ (77 ppm).

1. A copolymer containing units represented by the following formula (1) and cyclic olefin units: 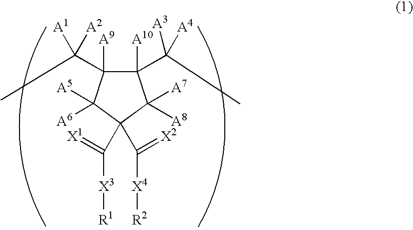
wherein X¹, X², X³ and X⁴ are independently of one another an atom of Group 16 in the Periodic Table of the elements; R¹ and R² are independently of each other a hydrogen atom or a hydrocarbyl group having 1 to 20 carbon atoms, and R¹ and R² may be linked with each other to form a ring; and A¹, A², A³, A⁴, A⁵, A⁶, A⁷, A⁸, A⁹ and A¹⁰ are independently of one another a hydrogen atom, a halogen atom, an alkyl group, an aralkyl group, an aryl group, a substituent-having silyl group, an alkoxy group, an aralkyloxy group, an aryloxy group, a disubstituent-having amino group, or a hydrocarbylthio group, and A⁵ and A⁶, or A⁷ and A⁸ may be linked with each other to form a ring.

2. The copolymer according to claim 1, wherein the units represented by the formula (1) comprises units represented by the following formula (2), whose A⁹ and A¹⁰ have a relative configuration of a trans-form: 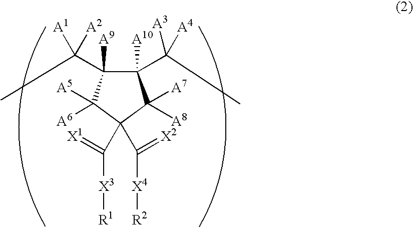
wherein all the symbols contained in the formula (2) are the same as those contained in the formula (1).

3. A process for producing a copolymer containing units represented by the following formula (1) and cyclic olefin units, which comprises the step of copolymerizing a compound represented by the following formula (3) with a cyclic olefin: 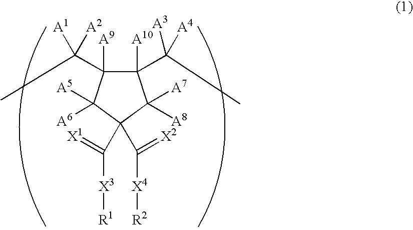 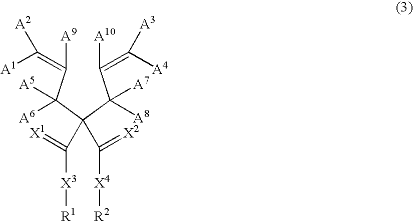
wherein X¹, X², X³ and X⁴ are independently of one another an atom of Group 16 in the Periodic Table of the elements; R¹ and R² are independently of each other a hydrogen atom or a hydrocarbyl group having 1 to 20 carbon atoms, and R¹ and R² may be linked with each other to form a ring; and A¹, A², A³, A⁴, A⁵, A⁶, A⁷, A⁸, A⁹ and A¹⁰ are independently of one another a hydrogen atom, a halogen atom, an alkyl group, an aralkyl group, an aryl group, a substituent-having silyl group, an alkoxy group, an aralkyloxy group, an aryloxy group, a disubstituent-having amino group, or a hydrocarbylthio group, and A⁵ and A⁶, or A⁷ and A⁸ may be linked with each other to form a ring.

4. The process for producing a copolymer according to claim 3, wherein the copolymerization is carried out in the presence of a polymerization catalyst formed by contacting a transition metal compound with an organoaluminum compound and/or boron compound.

5. The process for producing a copolymer according to claim 4, wherein the transition metal compound is a compound represented by the following formula [I]: 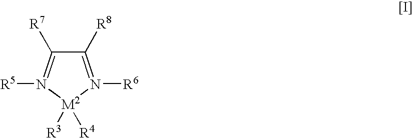
wherein M² is a transition metal atom of Group 10 of the Periodic Table of the elements; R³ and R⁴ are independently of each other a hydrogen atom, a halogen atom, an alkyl group, an aralkyl group, an aryl group, a silyl group, a siloxy group, an alkoxy group, an aralkyloxy group or an aryloxy group; R⁵ and R⁶ are independently of each other a hydrocarbyl group having 1 to 30 carbon atoms; and R⁷ and R⁸ are independently of each other a hydrogen atom or a hydrocarbyl group having 1 to 20 carbon atoms, and R⁷ and R⁸ may be linked with each other to form a ring.
